(19) United States
(12) Patent Application Publication
(10) Pub. No.: US 2005/0131779 A1
(43) Pub. Date: Jun. 16, 2005

(54) Production scheduling system

(75) Inventors: Koichi Kitamura, Yokohama (JP); Sachiko Iwamoto, Yokohama (JP); Kazuo Morita, Ebina (JP); Toshiaki Tomita, Ebina (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/033,433

(22) Filed: Jan. 10, 2005

Related U.S. Application Data
(62) Division of application No. 10/148,560, filed on Nov. 21, 2002.

(30) Foreign Application Priority Data
Nov. 29, 1999 (JP) 1999-338780

(51) Int. Cl. G06F 19/00

(52) U.S. Cl. 705/29; 705/8; 700/106

(57) ABSTRACT

The present invention provides a master production scheduling system in which overstocked parts are disposed of with minimum loss. The master production scheduling system refers to data stored in a data storage apparatus 101 and performs the following processing: an MRP explosion apparatus 115 explodes a product listed in a production plan into gross requirements; a retired parts estimating section 116 specifies overstocked parts based on the explosion results; a producible product quantity calculating section 117 calculates a producible product quantity for a retired model which can be produced using the overstocked parts; an additional parts order estimating section 118 calculates the value of an additional parts order (which is an amount of money to be paid for parts to be additionally ordered) for each quantity of retired model products to be produced; and a retired parts disposal section 120 drafts a production plan for the retired model in which the value of the additional parts order is minimized based on the producible product quantity and the value of the additional parts order.

### TECHNICAL FIELD

The present invention relates to a master production scheduling system, and particularly to a master production scheduling system which carries out disposal of overstocked parts, adjustment of sales and production plans, adjustment of a parts procurement plan, etc.

### BACKGROUND ART

A known technique for a master production scheduling system is disclosed in Japanese Laid-Open Patent Publication No. 11-15881 (1999). This technique relates to a master production scheduling system made up of a parts shortage eliminating apparatus and an overstocked parts eliminating apparatus. The parts shortage eliminating apparatus eliminates a parts shortage by deleting a portion of an entire production plan or purchasing additional parts. The overstocked parts eliminating apparatus, on the other hand, specifies all overstocked parts and adds production plans of products which use them to eliminate the surplus. The master production scheduling system thus revises a production plan which previously was not executable due to a parts shortage. Furthermore, the master production scheduling system minimizes overstocked parts inventory cost by adding production plans of products utilizing overstocked parts.

To reduce overstocked parts, the master production scheduling system using the above conventional technique comprises:

(1) a parts shortage estimating section for comparing gross requirements calculated from production planning information and information on a bill of materials against parts inventory information and a parts delivery schedule to estimate the types of parts in short supply and their quantity, clarifying the current parts shortage conditions;

(2) a parts shortage eliminating section for finding and listing products which use the above parts in short supply, and sequentially indicating to the operator whether other parts of each product are in short supply so that the operator can compare them, wherein if the operator sequentially selects the plan of each product as a target to be deleted in the order of products whose parts are in shorter supply, the parts shortage eliminating section deletes the selected plans from the entire production plan one after another until all the parts in short supply have been deleted from the production plan, turning the currently unexecutable production plan into an executable one;

(3) an overstocked parts estimating section for comparing gross requirements recalculated from executable production plan information and information on a bill of materials against the parts inventory information and parts purchase plan to estimate the types of overstocked parts and their quantity, clarifying the current parts surplus conditions (note: the overstocked parts obtained at this step includes the ones obtained as a result of deleting the plans of products which include parts in short supply in order to eliminate the parts shortage); and

(4) a parts surplus eliminating section for finding and listing products which use the above overstocked parts, and sequentially indicating to the operator whether other parts of each product are in excess so that the operator can compare them, wherein if the operator sequentially selects the plan of each product in the order of products which can be manufactured solely from overstocked parts and consume a larger number of overstocked parts, the parts surplus eliminating section adds the selected product plans to the production plan one after another as long as any more overstocked parts can be consumed, turning the current executable production plan into one which produces maximum profit (specifically, minimizing the overstocked parts inventory).

However, the conventional technique minimizes a surplus inventory based on evaluation of only product selling prices and surplus inventory cost. The technique does not maximize the cash flow (which is cash receipts minus cash disbursements). Therefore, when a production plan is modified (as in the case where a product is replaced by a new product, or production of an old product is ended), the conventional technique may increase loss as described below.

Firstly, the value of an additional order for parts necessary for product production to consume an overstocked parts inventory may exceed the product selling price, incurring gross loss which defeats the effect of a reduction in the cost incurred from parts obsolescence loss, increasing the total cost. Secondly, if the target products include many common parts, it is natural that the product production for consuming the overstocked parts inventory uses common parts used by current model products including marketable products, which leads to a shortage of common parts. As a result, it may become impossible to produce products having a high profit rate, incurring opportunity loss which defeats the effect of a reduction in the cost incurred from parts obsolescence loss, increasing the total cost. Thirdly, if a reduction in the price (cost) (obtained by utilizing overstocked parts) is smaller than a drop in the price of the product, the value of an additional order for parts necessary for product production to consume the overstocked parts inventory exceeds the proceeds from selling the overstocked parts to other companies as they are, increasing the total cost. That is, the conventional method may incur loss which defeats the effect of a reduction in a surplus inventory.

### DISCLOSURE OF INVENTION

The present invention is applied when drafting a production plan which determines how to dispose of an overstocked parts inventory, selecting from the following options (measures): (1) produce products utilizing the overstocked parts and make efforts to increase the sales; (2) sell the overstocked parts as they are; and (3) abandon the overstocked parts as they are. Specifically, the object of the present invention is to provide a master production scheduling system capable of evaluating profit and loss produced when the above measures are carried out so as to prevent the total loss from increasing.

To accomplish the above object, the present invention is based on the following concepts (and components). The master production scheduling system comprises:

(1) a retired parts estimating section for comparing gross requirements for a current model calculated from production planning information and information on a bill of materials on the current model against parts inventory information and a parts delivery schedule to determine overstocked parts (used for only retired models) from among parts listed in a parts inventory and a parts delivery schedule (thereby clarifying the inventory conditions and the delivery schedule of retired parts which may become excessive after a product model is retired);

(2) a producible product quantity calculating section for, based on retired model information, information on a bill of materials, a retired parts inventory, and a retired parts delivery schedule, calculating a producible product quantity for a retired model (thereby clarifying the producible product quantity for each retired model which can be produced using the parts which may become excessive);

(3) an additional parts order estimating section for, based on the producible product quantity for the retired model, the information on a bill of materials, parts purchasing price information, the retired parts inventory, and the retired parts delivery schedule, calculating the amount of money to be paid for parts to be additionally ordered for each quantity of retired model products to be produced (thereby clarifying the relationship between each production quantity for each retired model and the value of the additional parts order);

(4) a retired model sales amount calculating section, based on the producible product quantity for the retired model, product selling price information, and sellable product quantity information, calculating an amount of sales for the retired model (thereby clarifying the relationship between each production quantity for each retired model and the estimated amount of sales);

(5) a retired parts sales estimating section for, based on the producible product quantity for the retired model, the information on a bill of materials, the retired parts inventory, the retired parts delivery schedule, the parts purchasing price information, and sellable parts information, calculating estimated retired parts sales income to be earned from sales of retired parts which are not used for production of any product (thereby clarifying the relationship between each production quantity for each retired model and the estimated retired parts sales income);

(6) an additional manufacturing cost calculating section for, based on the producible product quantity for the retired model, the information on a bill of materials, and manufacturing cost information, calculating an additional manufacturing cost for each quantity of retired model products to be produced (thereby clarifying the relationship between each production quantity for each retired model and the additional manufacturing cost); and

(7) a production termination profit and loss calculating section for, based on the above retired parts inventory conditions and delivery schedule, the producible product quantity for the retired model, the value of the additional parts order for the retired model, the estimated sales amount for the retired model, the estimated retired parts sales income, and the additional manufacturing cost for the retired model, calculating profit or loss for each production quantity for the retired model (thereby clarifying the relationship between each production quantity for each retired model and the profit and loss); wherein products of the retired model continue to be produced until a production quantity has been reached at which profit is maximized (or loss is minimized) based on the relationship between each production quantity and the profit and loss clarified by the production termination profit and loss calculating section, and the remaining parts are sold as many as possible, abandoning the unsold parts; whereby when a production is ended, a retired parts surplus inventory can be disposed of with minimum loss.

To accomplish the above object, the present invention has a number of aspects as described below.

According to a first aspect of the present invention, a master production scheduling system capable of adjusting a production plan comprises: a data storage apparatus for storing production planning information on a product, information on a bill of materials, parts inventory information, a parts delivery schedule, parts purchasing price information, and retired model information; an MRP (an abbreviation for “material resource planning” indicating gross requirements) explosion apparatus for, based on the production planning information and the information on a bill of materials stored in the data storage apparatus, exploding a product to be produced into gross requirements; and a “retired model overstocked parts disposal method determining” apparatus (a determining apparatus) for determining a disposal method for overstocked parts to be used for a retired model; wherein the determining apparatus includes: a retired parts estimating section for comparing the gross requirements calculated by the MRP explosion apparatus against the parts inventory information and the parts delivery schedule to determine overstocked parts from among parts listed in a retired parts inventory and a retired parts delivery schedule; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; and a retired parts disposal section for, based on the value of the additional order and the production quantity (producible product quantity) for the retired model, drafting a production plan for the retired model in which the value of the additional order is minimized; whereby the retired parts inventory and parts listed in the retired parts delivery schedule can be disposed of with minimum loss.

According to a second aspect of the present invention, a master production scheduling system capable of adjusting a production plan comprises: a data storage apparatus for storing production planning information on a product, information on a bill of materials, parts inventory information, a parts delivery schedule, parts purchasing price information, retired model information, retired model product selling price information, and sellable product quantity information; an MRP (an abbreviation for “material resource planning” indicating gross requirements) explosion apparatus for, based on the production planning information and the information on a bill of materials stored in the data storage apparatus, exploding a product to be produced into gross requirements; and a determining apparatus for determining a disposal method for overstocked parts to be used for a retired model; wherein the determining apparatus includes: a retired parts estimating section for comparing the gross requirements calculated by the MRP explosion apparatus against the parts inventory information and the parts delivery schedule to determine overstocked parts from among parts listed in a retired parts inventory and a retired parts delivery schedule; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; and a retired parts disposal section for, based on the value of the additional order, the production quantity (producible product quantity) for the retired model, the retired model product selling price information, and the sellable product quantity information, drafting a production plan for the retired model in which profit is maximized (or loss is minimized); whereby the retired parts inventory and parts listed in the retired parts delivery schedule can be disposed of with minimum loss.

According to a third aspect of the present invention, a master production scheduling system capable of adjusting a production plan comprises: a data storage apparatus for storing production planning information on a product, information on a bill of materials, parts inventory information, a parts delivery schedule, parts purchasing price information, retired model information, retired model product selling price information, sellable product quantity information, parts selling price information, and sellable parts information; an MRP (an abbreviation for “material resource planning” indicating gross requirements) explosion apparatus for, based on the production planning information and the information on a bill of materials stored in the data storage apparatus, exploding a product to be produced into gross requirements; and a determining apparatus for determining a disposal method for overstocked parts to be used for a retired model; wherein the determining apparatus includes: a retired parts estimating section for comparing the gross requirements calculated by the MRP explosion apparatus against the parts inventory information and the parts delivery schedule to determine overstocked parts from among parts listed in a retired parts inventory and a retired parts delivery schedule; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; a retired parts sales estimating section for, based on the producible product quantity for the retired model, the information on a bill of materials, the retired parts inventory, the retired parts delivery schedule, the parts selling price information, and the sellable parts information, calculating estimated retired parts sales income to be earned from sales of retired parts which are not used for production of any product; and a retired parts disposal section for, based on the value of the additional order, the retired model, the retired model product selling price information, and the estimated retired parts sales income, drafting a production plan for the retired model in which profit is maximized (or loss is minimized); whereby the retired parts inventory and parts listed in the retired parts delivery schedule can be disposed of with minimum loss.

According to a fourth aspect of the present invention, a master production scheduling system capable of adjusting a production plan comprises: a data storage apparatus for storing production planning information on a product, information on a bill of materials, parts inventory information, a parts delivery schedule, parts purchasing price information, retired model information, retired model product selling price information, sellable product quantity information, and manufacturing cost information; an MRP (an abbreviation for “material resource planning” indicating gross requirements) explosion apparatus for, based on the production planning information and the information on a bill of materials stored in the data storage apparatus, exploding a product to be produced into gross requirements; and a determining apparatus for determining a disposal method for overstocked parts to be used for a retired model; wherein the determining apparatus includes: a retired parts estimating section for comparing the gross requirements calculated by the MRP explosion apparatus against the parts inventory information and the parts delivery schedule to determine overstocked parts from among parts listed in a retired parts inventory and a retired parts delivery schedule; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; an additional manufacturing cost calculating section for, based on the producible product quantity for the retired model, the information on a bill of materials, and the manufacturing cost information, calculating an additional manufacturing cost for each quantity of retired model products to be produced; and a retired parts disposal section for, based on the value of the additional order, the retired model, and the additional manufacturing cost, drafting a production plan for the retired model in which profit is maximized (or loss is minimized); whereby the retired parts inventory and parts listed in the retired parts delivery schedule can be disposed of with minimum loss.

According to a fifth aspect of the present invention, a product selling price determining system for determining a selling price of a product comprises: a data storage apparatus for storing production planning information on a product, information on a bill of materials, parts inventory information, a parts delivery schedule, parts purchasing price information, retired model information, and manufacturing cost information; an MRP (an abbreviation for “material resource planning” indicating gross requirements) explosion apparatus for, based on the production planning information and the information on a bill of materials stored in the data storage apparatus, exploding a product to be produced into gross requirements; and a determining apparatus for determining a disposal method for overstocked parts to be used for a retired model; wherein the determining apparatus includes: a retired parts estimating section for comparing the gross requirements calculated by the MRP explosion apparatus against the parts inventory information and the parts delivery schedule to determine overstocked parts from among parts listed in a retired parts inventory and a retired parts delivery schedule; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; and an additional manufacturing cost calculating section for, based on the producible product quantity for the retired model, the information on a bill of materials, and the manufacturing cost information, calculating an additional manufacturing cost for each quantity of retired model products to be produced; and a product selling price calculating section for, based on the value of the additional order, the retired model, and the additional manufacturing cost, calculating a product selling price at which no loss is incurred; whereby the retired parts inventory and parts listed in the retired parts delivery schedule can be disposed of with no loss.

According to a sixth aspect of the present invention, there is provided a production plan adjusting method for clearing out an overstocked parts inventory by first comparing a product production plan prepared beforehand against a parts inventory and a parts delivery schedule to determine the overstocked parts inventory and then carrying out a combination of one or more measures selected from among adjustment of the production plan, adjustment of a product selling price, sale of parts, cancellation of a parts order, and abandon of a parts inventory, the combination minimizing loss, the production plan adjusting method comprising the steps of: calculating gross requirements for the product production plan prepared beforehand and comparing the gross requirements against the parts inventory and the parts delivery schedule to determine a surplus part type and the quantity of inventoried parts of the surplus part type and the quantity of parts of the surplus part type to be warehoused; based on the quantity of inventoried parts of the surplus part type and the quantity of parts of the surplus part type to be warehoused, calculating a producible product quantity for a retired model; based on the overstocked parts inventory, the parts delivery schedule, the producible product quantity for the retired model, and a manufacturing cost, estimating, for each production quantity for the retired model, parts to be additionally ordered, a value of an additional order for the parts to be additionally ordered, an additional manufacturing cost, parts which are not used for the retired model, and the quantity of the parts which are not used for the retired model; calculating a sales amount for each production quantity (for the retired model) based on a selling price of the retired model, and calculating parts sales income and an unsold parts appraisal loss on an assumption that an upper limit sellable quantity of the parts which are not used are sold; and determining a production quantity for the retired model at which a difference obtained as a result of subtracting entire expenditure from entire income is maximized so as to clear out the overstocked parts inventory with minimum loss, the entire expenditure being a sum of the value of the additional order, the additional manufacturing cost, and the unsold parts appraisal loss, the entire income being a sum of the sales amount for the retired model and the parts sales income.

The master production scheduling systems according to the first to fourth aspects of the present invention may store a production plan of a current model as the production planning information. Furthermore, consider a case in which a production plan (information) has been already promised to the outside. In such a case, even if the production plan is of a retired model, it is necessary to produce the product. Therefore, a production plan for a retired model whose production has been already promised is treated as if it were of a current model. As a result, a seventh aspect of the present invention may be derived from any one of the first to fourth aspects, wherein the seventh aspect stores production planning information on a current model and/or production planning information on a retired model whose sale has been already promised, as the production planning information on a product.

Further, the product selling price determining system according to the fifth aspect of the present invention may also store a production plan of a current model as the production planning information. Furthermore, when a production plan (information) has been already promised to the outside, it is also necessary to produce the product even if the production plan is of a retired model. Therefore, a production plan for a retired model whose production has been already promised is treated as if it ware of a current model. As a result, an eighth aspect of the present invention may be derived from the fifth aspect, wherein the eighth aspect stores production planning information on a current model and/or production planning information on a retired model whose sale has been already promised, as the production planning information on a product.

Further, when no production plan (information) has been promised to the outside and all models are set as retired models, the entire production plan may be ignored. As a result, the following aspects (ninth to twelfth aspects) of the present invention may be derived from the second to fifth aspects, respectively.

According to a ninth aspect of the present invention, a master production scheduling system capable of adjusting a production plan comprises: a data storage apparatus for storing information on a bill of materials, parts inventory information, a parts delivery schedule, parts purchasing price information, retired model information, retired model product selling price information, and sellable product quantity information; and a determining apparatus for determining a disposal method for overstocked parts to be used for a retired model; wherein the determining apparatus includes: a retired parts estimating section for setting the parts inventory information and the parts delivery schedule as information on parts listed in a retired parts inventory and a retired parts delivery schedule, both used for only a retired model; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; and a retired parts disposal section for, based on the value of the additional order and the production quantity (producible product quantity) for the retired model, drafting a production plan for the retired model in which profit is maximized (or loss is minimized); whereby the retired parts inventory and parts listed in the retired parts delivery schedule can be disposed of with minimum loss.

According to a tenth aspect of the present invention, a master production scheduling system capable of adjusting a production plan comprises: a data storage apparatus for storing information on a bill of materials, parts inventory information, a parts delivery schedule, parts purchasing price information, retired model information, retired model product selling price information, sellable product quantity information, parts selling price information, and sellable parts information; and a determining apparatus for determining a disposal method for overstocked parts to be used for a retired model; wherein the determining apparatus includes: a retired parts estimating section for setting the parts inventory information and the parts delivery schedule as information on parts listed in a retired parts inventory and a retired parts delivery schedule, both used for only a retired model; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; a retired parts sales estimating section for, based on the producible product quantity for the retired model, the information on a bill of materials, the retired parts inventory, the retired parts delivery schedule, the parts selling price information, and the sellable parts information, calculating estimated retired parts sales income to be earned from sales of retired parts which are not used for production of any product; and a retired parts disposal section for, based on the value of the additional order, the retired model, and the estimated retired parts sales income, drafting a production plan for the retired model in which profit is maximized (or loss is minimized); whereby the retired parts inventory and parts listed in the retired parts delivery schedule can be disposed of with minimum loss.

According to an eleventh aspect of the present invention, a master production scheduling system capable of adjusting a production plan comprises: a data storage apparatus for storing information on a bill of materials, parts inventory information, a parts delivery schedule, parts purchasing price information, retired model information, retired model product selling price information, sellable product quantity information, and manufacturing cost information; and a determining apparatus for determining a disposal method for overstocked parts to be used for a retired model; wherein the determining apparatus includes: a retired parts estimating section for setting the parts inventory information and the parts delivery schedule as information on parts listed in a retired parts inventory and a retired parts delivery schedule, both used for only a retired model; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; an additional manufacturing cost calculating section for, based on the producible product quantity for the retired model, the information on a bill of materials, and the manufacturing cost information, calculating an additional manufacturing cost for the production quantity (producible product quantity) for the retired model; and a retired parts disposal section for, based on the value of the additional order, the retired model, and the additional manufacturing cost, drafting a production plan for the retired model in which profit is maximized (or loss is minimized); whereby the retired parts inventory and parts listed in the retired parts delivery schedule can be disposed of with minimum loss.

According to a twelfth aspect of the present invention, a product selling price determining system for determining a selling price of a product comprises: a data storage apparatus for storing information on a bill of materials, parts inventory information, a parts delivery schedule, parts purchasing price information, retired model information, and manufacturing cost information; and a determining apparatus for determining a disposal method for overstocked parts to be used for a retired model; wherein the determining apparatus includes: a retired parts estimating section for setting the parts inventory information and the parts delivery schedule as information on parts listed in a retired parts inventory and a retired parts delivery schedule, both used for only a retired model; a producible product quantity calculating section for, based on the retired model information, the information on a bill of materials, the retired parts inventory, and the retired parts delivery schedule, calculating a producible product quantity for a retired model; an additional parts order estimating section for, based on the producible product quantity for the retired model, the information on a bill of materials, the parts purchasing price information, the retired parts inventory, and the retired parts delivery schedule, calculating an amount of money to be paid for parts to be additionally ordered (a value of an additional order) for each quantity of retired model products to be produced; an additional manufacturing cost calculating section for, based on the producible product quantity for the retired model, the information on a bill of materials, and the manufacturing cost information, calculating an additional manufacturing cost for each quantity of retired model products to be produced; and a product selling price calculating section for, based on the value of the additional order, the retired model, and the manufacturing cost, calculating a product selling price at which no loss is incurred; whereby the retired parts inventory and parts listed in the retired parts delivery schedule can be disposed of with no loss.

Furthermore, in the following aspects (a thirteenth aspect and a fourteenth aspect), the planner drafts a production plan for a retired model while checking product selling prices, parts selling prices, and the values of additional orders.

According to a thirteenth aspect of the present invention, a production planning support system for helping adjust a production plan stores information on a producible product quantity for a retired model and information on a value of an additional order (which is an amount of money to be paid for parts to be additionally ordered) for each quantity of retired model products to be produced, the production planning support system displaying: a producible product quantity calculation results screen for indicating to a planner a relationship between the production quantity (producible product quantity) for the retired model and the value of the additional order; a detailed parts information screen for indicating to the planner a relationship between the production quantity for the retired model and the parts to be additionally ordered; and an additional production plan input screen for enabling the planner to register a plan while referring to the producible product quantity calculation results screen and the detailed parts information screen; wherein the production planning support system comprises: a retired parts disposal section for helping the planner to, based on the value of the additional order and the production quantity (producible product quantity) for the retired model, determine a production plan for the retired model, the planner aiming to dispose of a retired parts inventory and parts listed in a retired parts delivery schedule with minimum loss; whereby the retired parts inventory and parts listed in the retired parts delivery schedule can be disposed of with minimum loss.

According to a fourteenth aspect of the present invention, a production planning support system for helping adjust a production plan stores information on a producible product quantity for a retired model, information on a value of an additional order (which is an amount of money to be paid for parts to be additionally ordered) for each quantity of retired model products to be produced, and information on estimated retired parts sales income to be earned from sales of retired parts which are not used for production of any product, the production planning support system displaying: a producible product quantity calculation results screen for indicating to a planner relationships among the production quantity (producible product quantity) for the retired model, the value of the additional order, and the estimated retired parts sales income; a detailed parts information screen for indicating to the planner relationships among the production quantity for the retired model, the value of the additional order, and the parts to be sold; and an additional production plan input screen for enabling the planner to register a plan while referring to the producible product quantity calculation results screen and the detailed parts information screen; wherein the production planning support system comprises: a retired parts disposal section for helping the planner to, based on the value of the additional order, the estimated retired parts sales income, and the production quantity (producible product quantity) for the retired model, draft a plan, the planner aiming to dispose of a retired parts inventory and parts listed in a retired parts delivery schedule with minimum loss; whereby the retired parts inventory and parts listed in the retired parts delivery schedule can be disposed of with minimum loss.

The present invention also has the following aspects (a fifteenth aspect and a sixteenth aspect) as production plan adjusting methods.

According to a fifteenth aspect of the present invention, a production plan adjusting method capable of adjusting a production plan comprises the steps of: storing production planning information on a product, information on a bill of materials including names of parts constituting the product and time required for manufacturing the product from the parts, parts inventory information, a parts delivery schedule, parts purchasing price information, and retired model information; based on the production planning information and the information on a bill of materials, exploding a product to be produced into gross requirements; comparing the gross requirements against the parts inventory information and the parts delivery schedule to determine overstocked parts from among parts listed in a retired parts inventory and a retired parts delivery schedule; based on the retired model information, the information on a bill of materials, the retired parts inventory, and the retired parts delivery schedule, calculating a producible product quantity for a retired model; based on the producible product quantity for the retired model, the information on a bill of materials, the parts purchasing price information, the retired parts inventory, and the retired parts delivery schedule, calculating a value of an additional order (which is an amount of money to be paid for parts to be additionally ordered) for each quantity of retired model products to be produced; and based on the value of the additional order and the producible product quantity for the retired model, drafting a production plan for the retired model in which the value of the additional order is minimized; whereby the retired parts inventory and parts listed in the retired parts delivery schedule can be disposed of with minimum loss.

According to a sixteenth aspect of the present invention, a production plan adjusting method capable of adjusting a production plan comprises the steps of: storing production planning information on a product, information on a bill of materials including names of parts constituting the product and time required for manufacturing the product from the parts, parts inventory information, a parts delivery schedule, parts purchasing price information, retired model information, retired model product selling price information, retired model sellable product quantity information, parts selling price information, sellable parts information, and manufacturing cost information; based on the production planning information and the information on a bill of materials, exploding a product to be produced into gross requirements; comparing the gross requirements against the parts inventory information and the parts delivery schedule to determine overstocked parts from among parts listed in a retired parts inventory and a retired parts delivery schedule; based on the retired model information, the information on a bill of materials, the retired parts inventory, and the retired parts delivery schedule, calculating a producible product quantity for a retired model; based on the producible product quantity for the retired model, the information on a bill of materials, the parts purchasing price information, the retired parts inventory, and the retired parts delivery schedule, calculating a value of an additional order (which is an amount of money to be paid for parts to be additionally ordered) for each quantity of retired model products to be produced; based on the producible product quantity for the retired model, the information on a bill of materials, the retired parts inventory, the retired parts delivery schedule, the parts selling price information, and the sellable parts information, calculating estimated retired parts sales income to be earned from sales of retired parts which are not used for production of any product; based on the producible product quantity for the retired model, the information on a bill of materials, and the manufacturing cost information, calculating an additional manufacturing cost for each quantity of retired model products to be produced; and based on the value of the additional order, the producible product quantity for the retired model, the retired model product selling price information, the retired model sellable product quantity information, the estimated retired parts sales income, and the additional manufacturing cost, drafting a production plan for the retired model in which profit is maximized (or loss is minimized); whereby the retired parts inventory and parts listed in the retired parts delivery schedule can be disposed of with minimum loss.

The present invention also has the following aspects (a seventeenth aspect and an eighteenth aspect) as computer-readable storage media which store a program for causing a computer to perform the above production plan adjusting methods.

According to a seventeenth aspect of the present invention, a computer-readable storage medium stores a program for causing a computer to perform a production plan adjusting method capable of adjusting a production plan, the program having the functions of: storing production planning information on a product, information on a bill of materials including names of parts constituting the product and time required for manufacturing the product from the parts, parts inventory information, a parts delivery schedule, parts purchasing price information, and retired model information; based on the production planning information and the information on a bill of materials, exploding a product to be produced into gross requirements; comparing the gross requirements against the parts inventory information and the parts delivery schedule to determine overstocked parts from among parts listed in a retired parts inventory and a retired parts delivery schedule; based on the retired model information, the information on a bill of materials, the retired parts inventory, and the retired parts delivery schedule, calculating a producible product quantity for a retired model; based on the producible product quantity for the retired model, the information on a bill of materials, the parts purchasing price information, the retired parts inventory, and the retired parts delivery schedule, calculating a value of an additional order (which is an amount of money to be paid for parts to be additionally ordered) for each quantity of retired model products to be produced; and based on the value of the additional order and the producible product quantity for the retired model, drafting a production plan for the retired model in which the value of the additional order is minimized; whereby the retired parts inventory and parts listed in the retired parts delivery schedule can be disposed of with minimum loss.

According to an eighteenth aspect of the present invention, a computer-readable storage medium stores a program for causing a computer to perform a production plan adjusting method capable of adjusting a production plan, the program having the functions of: storing production planning information on a product, information on a bill of materials including names of parts constituting the product and time required for manufacturing the product from the parts, parts inventory information, a parts delivery schedule, parts purchasing price information, retired model information, retired model product selling price information, retired model sellable product quantity information, parts selling price information, sellable parts information, and manufacturing cost information; based on the production planning information and the information on a bill of materials, exploding a product to be produced into gross requirements; comparing the gross requirements against the parts inventory information and the parts delivery schedule to determine overstocked parts from among parts listed in a retired parts inventory and a retired parts delivery schedule; based on the retired model information, the information on a bill of materials, the retired parts inventory, and the retired parts delivery schedule, calculating a producible product quantity for a retired model; based on the producible product quantity for the retired model, the information on a bill of materials, the parts purchasing price information, the retired parts inventory, and the retired parts delivery schedule, calculating a value of an additional order (which is an amount of money to be paid for parts to be additionally ordered) for each quantity of retired model products to be produced; based on the producible product quantity for the retired model, the information on a bill of materials, the retired parts inventory, the retired parts delivery schedule, the parts selling price information, and the sellable parts information, calculating estimated retired parts sales income to be earned from sales of retired parts which are not used for production of any product; based on the producible product quantity for the retired model, the information on a bill of materials, and the manufacturing cost information, calculating an additional manufacturing cost for each quantity of retired model products to be produced; and based on the value of the additional order, the producible product quantity for the retired model, the retired model product selling price information, the retired model sellable product quantity information, the estimated retired parts sales income, and the additional manufacturing cost, drafting a production plan for the retired model in which profit is maximized (or loss is minimized); whereby the retired parts inventory and parts listed in the retired parts delivery schedule can be disposed of with minimum loss.

### BRIEF DESCRIPTION OF DRAWINGS

FIG. 1 is a diagram showing a configuration of apparatuses for a master production scheduling system according to the present invention.

FIG. 2 is a flowchart schematically showing a production plan adjustment algorithm according to the present invention.

FIG. 3 is an explanatory diagram showing the component parts of products A and B having common parts between them.

FIG. 4(a) is an explanatory diagram showing an original production plan for the product A; FIG. 4(b) is an explanatory diagram showing the quantity of parts a to be warehoused; and FIG. 4(c) is an explanatory diagram showing the quantity of parts a to be inventoried.

FIG. 5 is an explanatory diagram showing estimated changes in the purchasing price of part a.

FIG. 6 is an explanatory diagram showing a list of retired models.

FIG. 7 is a flowchart showing the details of the algorithm executed at step 201 shown in FIG. 2.

FIG. 8(a) is an explanatory diagram showing changes in the required quantity of parts a, while FIG. 8(b) is an explanatory diagram showing changes in the required quantity of parts b.

FIG. 9 is a flowchart showing the details of the algorithm executed at step 202 shown in FIG. 2.

FIG. 10 is a flowchart showing the details of the algorithm executed at step 203 shown in FIG. 2.

FIG. 11(a) is an explanatory diagram showing the inventory of part c; FIG. 11(b) is an explanatory diagram showing the quantity of parts c to be warehoused; and FIG. 11(c) is an explanatory diagram showing an estimated inventory obtained as a result of combining the delivery schedule for part c with the original inventory of part c.

FIG. 12 is a flowchart showing the details of the algorithm executed at step 204 shown in FIG. 2.

FIG. 13 is an explanatory diagram showing the relationship between a production quantity and the value of an additional parts order obtained as a result of executing the flowchart shown in FIG. 12.

FIG. 14 is an explanatory diagram showing screens for helping draft a production plan.

FIG. 15 is an explanatory diagram showing other screens for helping draft a production plan.

FIG. 16 is a diagram showing a hardware configuration of the master production scheduling system according to the present invention.

FIG. 17 is a diagram showing another configuration of apparatuses for the master production scheduling system according to the present invention.

FIG. 18 is a flowchart schematically showing a production plan adjustment algorithm according to the present invention.

FIG. 19 is an explanatory diagram showing the component parts of products A and B having common parts between them.

FIG. 20(a) is an explanatory diagram showing an original production plan for the product A; FIG. 20(b) is an explanatory diagram showing the quantity of parts a to be warehoused; and FIG. 20(c) is an explanatory diagram showing the quantity of parts a to be inventoried.

FIG. 21(a) is an explanatory diagram showing estimated changes in the purchasing price of part a; FIG. 21(b) is an explanatory diagram showing changes in the selling price of the product A; and FIG. 21(c) is an explanatory diagram showing estimated changes in the selling price of part a.

FIG. 22(a) is an explanatory diagram showing a list of retired models; FIG. 22(b) is an explanatory diagram showing the sellable product quantity for each model; FIG. 22(c) is an explanatory diagram showing the sellable part quantity for each part type; and FIG. 22(d) is an explanatory diagram showing a manufacturing cost for each model.

FIG. 23 is a flowchart showing the details of the algorithm executed at step 1601 shown in FIG. 18.

FIG. 24(a) is an explanatory diagram showing changes in the required quantity of parts a, while FIG. 24(b) is an explanatory diagram showing changes in the required quantity of parts b.

FIG. 25 is a flowchart showing the details of the algorithm executed at step 1602 shown in FIG. 18.

FIG. 26 is a flowchart showing the details of the algorithm executed at step 1603 shown in FIG. 18.

FIG. 27(a) is an explanatory diagram showing the inventory of part c; FIG. 27(b) is an explanatory diagram showing the quantity of parts c to be warehoused; and FIG. 27(c) is an explanatory diagram showing an estimated inventory obtained as a result of combining the delivery schedule for part c with the original inventory of part c.

FIG. 28 is a flowchart showing the details of the algorithm executed at step 1604 shown in FIG. 18.

FIG. 29 is a flowchart showing the details of the algorithm executed at step 2601 shown in FIG. 28.

FIG. 30 is an explanatory diagram showing the relationship between a production quantity and the value of an additional parts order obtained as a result of executing step 2601 shown in FIG. 28.

FIG. 31 is an explanatory diagram showing the relationship between a production quantity and profit and loss obtained as a result of executing step 2605 shown in FIG. 28.

FIG. 32 is an explanatory diagram showing screens for helping draft a production plan when no parts are sold.

FIG. 33 is an explanatory diagram showing screens for helping draft a production plan when parts are sold.

FIG. 34 is a flowchart showing a product selling price determination algorithm.

FIG. 35 is a flowchart showing the details of the algorithm executed at step 3004 shown in FIG. 34.

FIG. 36 is a diagram showing a hardware configuration of the master production scheduling system according to the present invention.

### BEST MODES FOR CARRYING OUT THE INVENTION

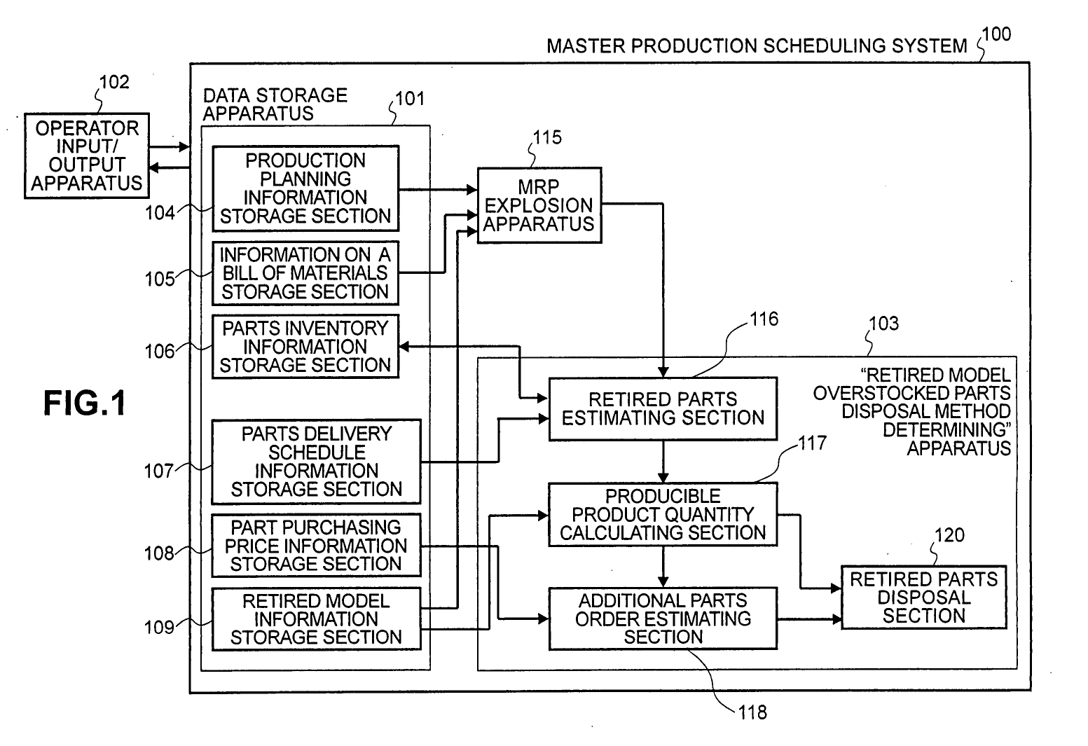

FIG. 1 shows a functional configuration of a master production scheduling system according to the present invention. As shown in FIG. 1, a master production scheduling system 100 of the present invention comprises an MRP explosion apparatus 115, a “retired model overstocked parts disposal method determining” apparatus 103, and a data storage apparatus 101. It should be noted that the master production scheduling system may comprise an operator input/output apparatus 102.

The above data storage apparatus 101 comprises: a production planning information storage section 104 for storing production plans drafted beforehand; a information on a bill of materials storage section 105 for storing a component parts list and production lead time (time required for manufacturing a product from its component parts) for each product; a parts inventory information storage section 106 for storing the current inventory state of each part; a parts delivery schedule storage section 107 for storing a delivery schedule on each ordered part; a parts purchasing price information storage section 108 for storing an estimated unit purchasing price of each part to be purchased in the future; and a retired model information storage section 109 for storing the names of retiring (retired) product models. An example of how data stored by each section within the data storage apparatus 101 is displayed on the operator input/output apparatus 102 will be described later.

The above MRP explosion apparatus 115 carries out MRP explosion. “MRP” is an abbreviation for “material resource planning”, indicating estimation of gross requirements. An MRP explosion process obtains the name of each part and its quantity needed to produce each product according to a production plan stored in the above production planning information storage section 104 and the time period in which the parts should be procured by referring to the component parts list and the production lead time of each product stored in the above information on a bill of materials storage section 105.

The above “retired model overstocked parts disposal method determining” apparatus 103 comprises: a retired parts estimating section 116 for estimating the parts inventory and the parts delivery schedule for a retired model based on the output of the MRP explosion apparatus 115; a producible product quantity calculating section 117 for calculating a producible product quantity for the retired model based on the above parts inventory and parts delivery schedule for the retired model; an additional parts order estimating section 118 for estimating parts to be additionally ordered and the amount of money to be paid for them (the value of the additional parts order) when a quantity of products of the retired model equal to the producible product quantity are produced; and a retired parts disposal section 120 for clearing out the retired parts inventory and parts listed in the retired parts delivery schedule such that the value of the additional parts order is minimized based on the producible product quantity for the retired model and the parts to be additionally ordered and the value of the additional parts order.

The operator input/output apparatus 102 can indicate to the operator data stored in each section of the data storage apparatus 101. The operator input/output apparatus 102 also can receive information for updating the data stored in each section of the data storage apparatus 101. Furthermore, when the operator drafts a production plan for a retired model in an interactive manner, the operator input/output apparatus 102 can display a screen for helping draft the plan.

The master production scheduling system 100 also includes programs used for processing to indicate data to the operator input/output apparatus 102, input data processing, etc.

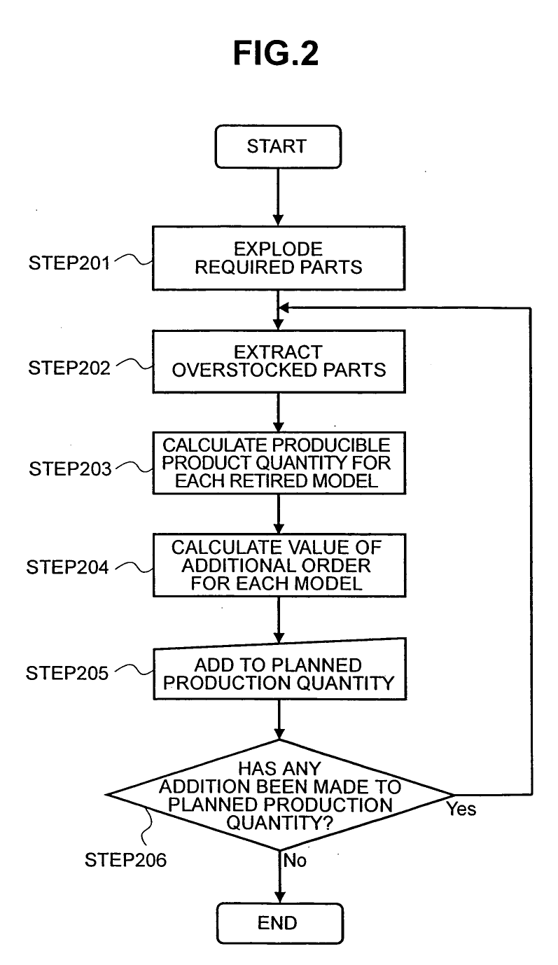

FIG. 2 shows a production plan adjustment algorithm according to the present invention. This algorithm realizes the above “retired model overstocked parts disposing method determining” apparatus 103.

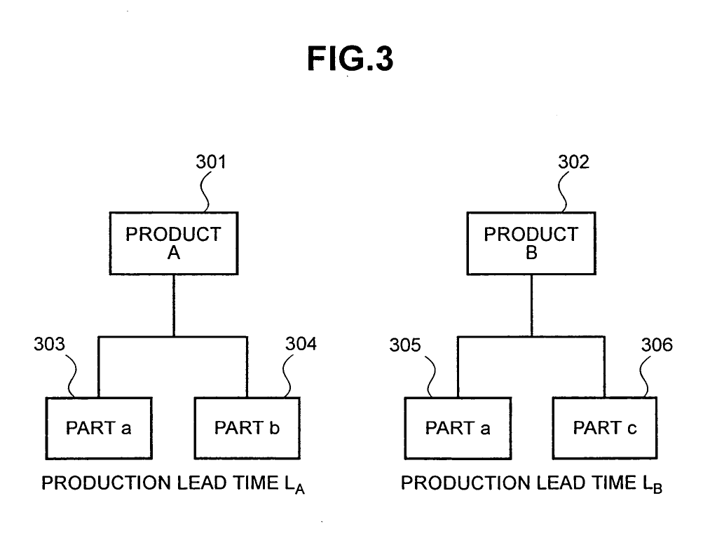

With reference to FIGS. 2 and 4 to 15, description will be made below of a production plan adjustment according to an embodiment of the present invention by use of products A301 and B302 whose component parts lists are shown in FIG. 3. Thus, two types of products, namely product types A and B, are used as examples. The product A301 is made up of parts a303 and b304. Reference numeral L_{A} denotes a production lead time required for manufacturing the product A301 from the parts a303 and b304.

The product B302, on the other hand, is made up of parts a305 and c306. Reference numeral L_{B} denotes a production lead time required for manufacturing the product B302 from the parts a305 and c306. The parts a303 and a305 are common parts between the products A301 and B302. This information is stored in the information on a bill of materials storage section 105 in the data storage apparatus 101.

It should be noted that each figure indicates data in a state in which the data is displayed on the screen of the operator input/output apparatus 102 for convenience even though the data is stored in a different form. Thus, in the present embodiment, the data configuration of information stored in the data storage apparatus 101 is indicated in a form in which the information (data) is displayed on the screen of the operator input/output apparatus 102.

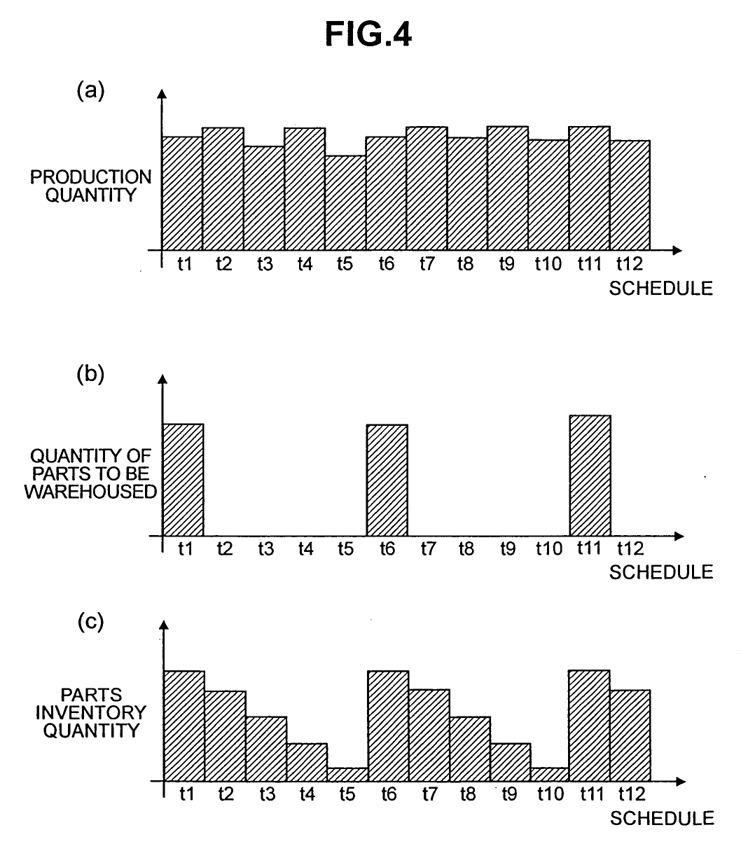

FIG. 4(a) shows an example of production planning information stored in the production planning information storage section 104 in the data storage apparatus 101. Specifically, FIG. 4(a) indicates the production plan of the product A301, wherein the horizontal axis indicates each time period of the schedule and the vertical axis indicates the number of products A301 to be completed for each time period.

FIG. 4(b) shows an example of a parts delivery schedule stored in the parts delivery schedule storage section 107 in the data storage apparatus 101. Specifically, FIG. 4(b) indicates the parts delivery schedule of the part a303 of the product A301, wherein the horizontal axis indicates each time period of the schedule in which parts are warehoused and the vertical axis indicates their quantity.

FIG. 4(c) shows an example of parts inventory information stored in the parts inventory information storage section 106 in the data storage apparatus 101. Specifically, FIG. 4(c) indicates the inventory (schedule) of the part a303 of the product A301, wherein the horizontal axis indicates each time period of the schedule and the vertical axis indicates the total inventory (the number of warehoused parts minus the number of retrieved parts).

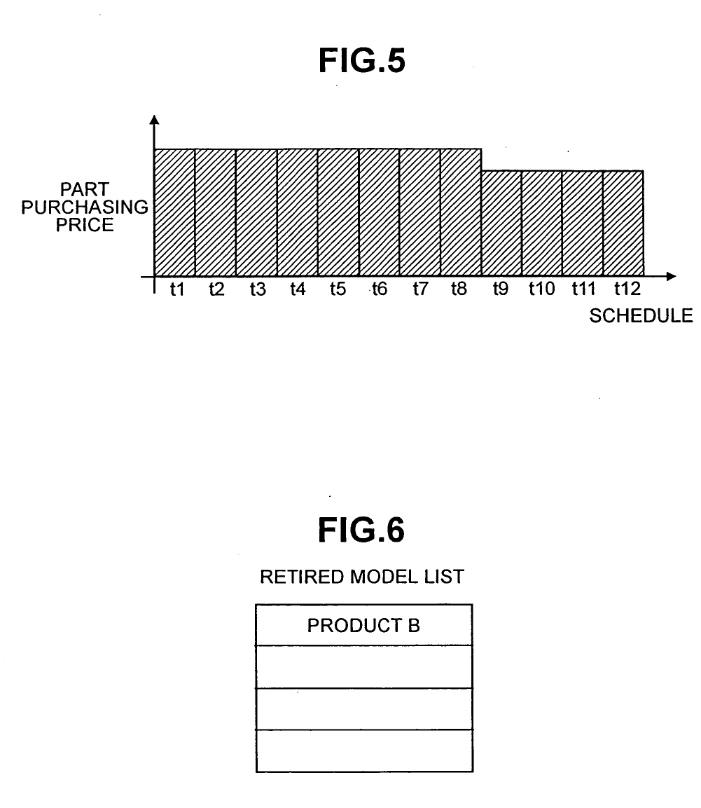

FIG. 5 shows an example of parts purchasing price information stored in the parts purchasing price information section 108 in the data storage apparatus 101. Specifically, FIG. 5 indicates changes in the purchasing price of the part a303 of the product A301, wherein the horizontal axis indicates each time period of the parts delivery schedule and the vertical axis indicates the purchasing price of the part.

FIG. 6 shows an example of retired model information stored in the retired model information storage section 109 in the data storage apparatus 101. In this example, the product B302 is registered as a retired model.

Description will be made below of production plan adjustment carried out by a production plan adjusting system of the present invention with reference to accompanying drawings. FIG. 2 schematically shows a production plan adjusting method.

As shown in FIG. 2, based on a predetermined production plan, the production plan adjusting system of the present invention explodes a product into required quantities of parts at step 201 and extracts overstocked parts based on the exploded required part quantities at step 202. Step 203 calculates the number of products which can be produced (producible product quantity) for each retired model based on the overstocked parts extracted at step 202. Step 204 calculates the value of an additional parts order for each quantity of products of each model using the producible product quantity for the model calculated at step 203. Step 205 determines a planned production quantity for each retired model and adds it to the production plan based on the value of the additional parts order (calculated at step 204) for each quantity of products of each model. Step 206 determines whether any addition has been made to the planned production quantity at step 205. If it is determined that some addition has been made to the planned production quantity, the process flow returns to step 202. If it is determined that no addition has been made to the planned production quantity, on the other hand, the process flow ends. Steps 202 to 206 are repeated to finally determine a production quantity for each retired model.

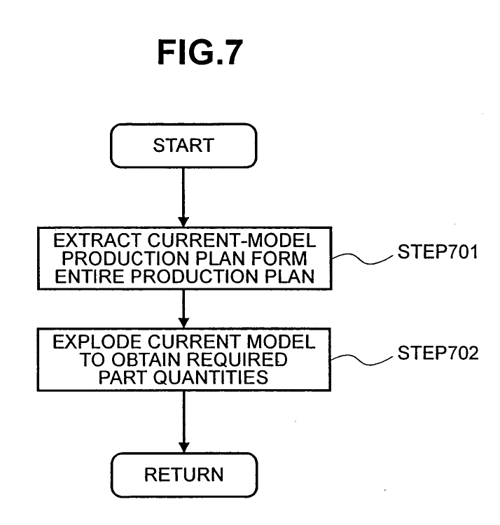

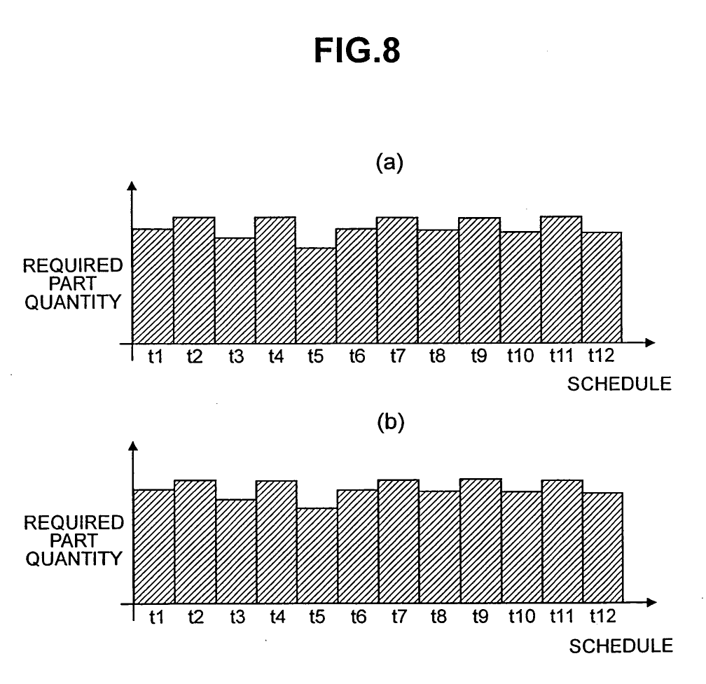

FIG. 7 shows the details of step 201, which is carried out by the MRP explosion apparatus 115. First of all, step 701 extracts a current-model production plan based on the above production planning information and retired model information. In this example, the retired model is the product B as indicated in FIG. 6. Therefore, the current-model production plan is obtained as a result of removing the plan of the product B from the entire production plan. The current-model production plan is indicated by FIG. 4(a). Step 702 calculates required part quantities for a current model based on the above information on a bill of materials and current-model production plan. Specifically, from a parts list, step 702 estimates each part type and its quantity required to produce a quantity of products determined by the production plan. In the example of FIG. 3, 50 parts a303 and 50 parts b304 are needed to manufacture 50 products A301. As described above, since a production plan is a schedule indicating time periods (intervals) and the quantity of products to be completed in each time period, the required quantities of the parts a303 and b304 for each time period are calculated based on the production plan of the product A, considering each production lead time. The required quantities of the parts a303 and b304 are calculated as indicated by FIGS. 8(a) and 8(b). In each figure, the horizontal axis indicates each time period of the schedule in which parts are needed, while the vertical axis indicates the required quantity of the parts.

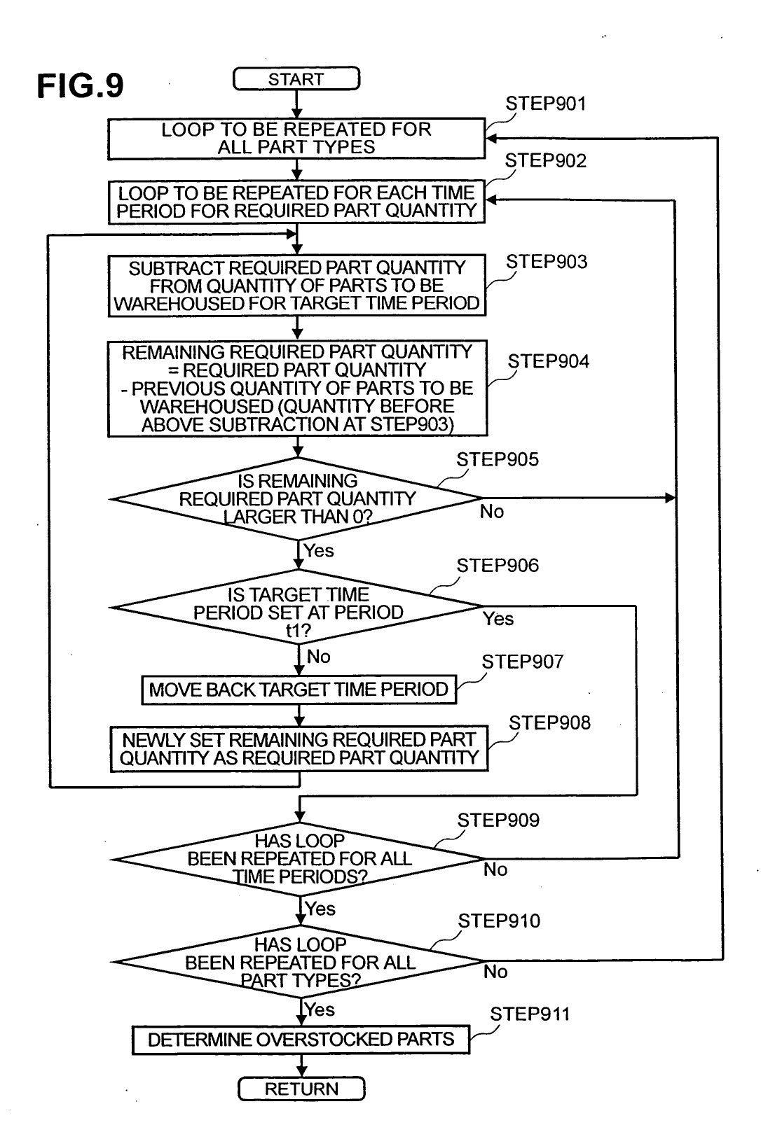

FIG. 9 shows the details of step 202. Step 202 is carried out by the above retired parts estimating section 116. First of all, step 901 starts a loop consisting of the subsequent steps 902 through 909 to be repeated for all part types. The next step 902 starts another loop consisting of the subsequent steps 903 through 908 to be repeated for each time period of the schedule in which parts are need. For a target part type and in a target time period, step 903 subtracts the required part quantity from the quantity of parts to be warehoused. However, if the target time period is the time period t1 in the figure, step 903 subtracts the required part quantity from the sum of the inventory (quantity) up to that time period and the quantity of parts to be warehoused. At that time, when the required part quantity is larger than the quantity of the parts to be warehoused, step 903 subtracts only a part quantity equal to the quantity of the parts to be warehoused.

Then, step 904 subtracts the quantity of the parts to be warehoused (which is the quantity before the above subtraction at step 903) from the required part quantity to produce a remaining required part quantity. The remaining required part quantity indicates the part quantity by which the required part quantity exceeds the quantity of the parts to be warehoused for the target time period. Then, step 905 checks whether the remaining required part quantity is larger than 0. If it is not larger than 0, the processing flow proceeds to step 902, and the required part quantity for the next time period is subtracted. If the remaining required part quantity is larger than 0, on the other hand, the processing flow proceeds to step 906.

Step 906 determines whether the target time period in which parts are needed is the time period t1. If it is determined that the target time period is the time period t1, the processing flow proceeds to step 909. If it is determined that the target time period is not the time period t1, on the other hand, the processing flow proceeds to step 907. Step 907 moves back the target time period to the previous time period (for the remaining required part quantity). For example, if the required part quantity is larger than the quantity of parts to be warehoused in the time period t5, the processing flow proceeds to a processing step at which the remaining required part quantity is subtracted from the quantity of parts to be warehoused in the time period t4.

Then, step 908 newly sets the remaining required part quantity as the required part quantity, and the processing flow proceeds to step 909. Step 909 determines whether steps 903 through 908 have been repeated for all time periods of the schedule to process the required part quantities. If it is determined that the steps have not yet been repeated for all time periods to process the required part quantities, the processing flow returns to step 902. If it is determined that the steps have been repeated for all time periods to process the required part quantities, the processing flow proceeds to step 910. Step 910 determines whether steps 902 through 909 have been repeated for all part types. If it is determined that the steps have not yet been repeated for all part types, the processing flow returns to step 901. If it is determined that the steps have been repeated for all part types, the processing flow proceeds to step 911. Step 911 sets as an overstocked parts quantity the quantity of parts to be warehoused for each time period from which any required part quantity has not been subtracted (or, for the time period t1, the sum of the inventory up to that time period and the quantity of parts to be warehoused for that time period), and the processing flow ends.

As described above, steps 903 through 908 are repeated so as to subtract each required part quantity from the quantity of parts to be warehoused in the corresponding time period and thereby calculate the quantity of parts to be warehoused which are not used for a current model, that is, the (quantity of) overstocked parts.

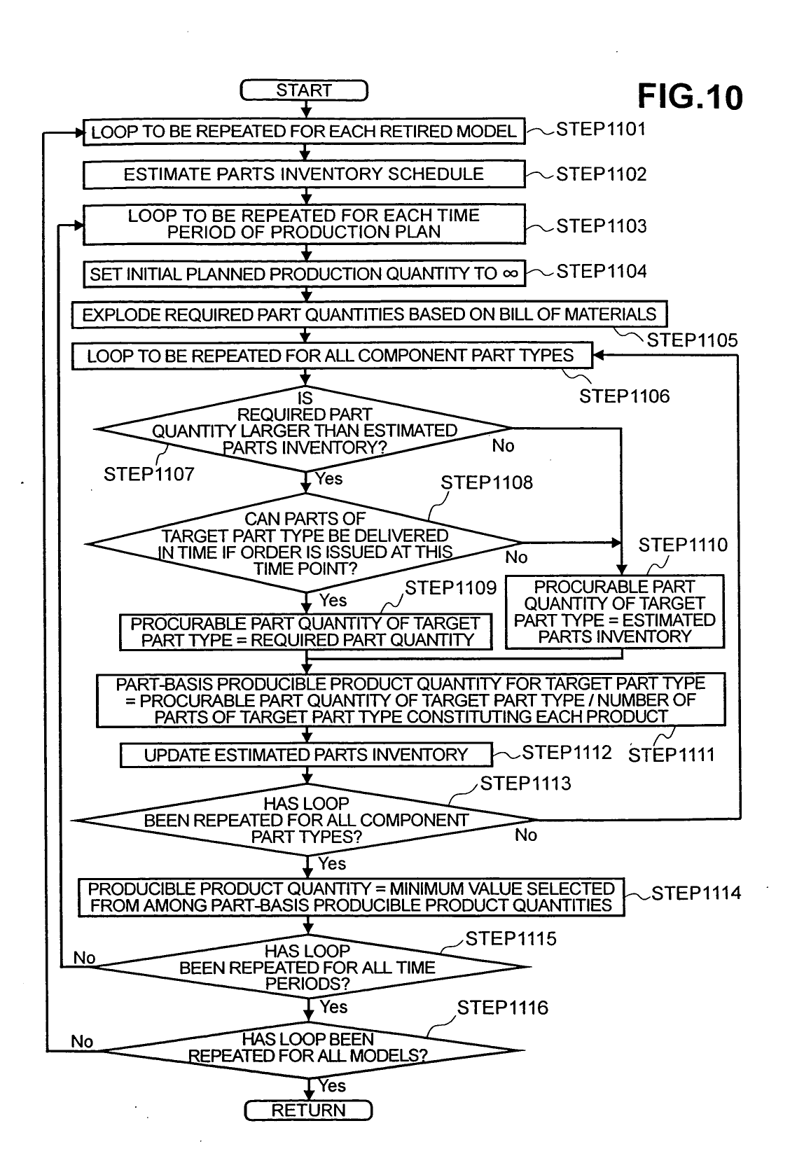

FIG. 10 shows the details of step 203. This example shows a method for calculating the number of products which can be produced (a producible product quantity) for each model. First of all, step 1101 starts a loop consisting of the subsequent steps 1102 through 1115 to be repeated for each retired model.

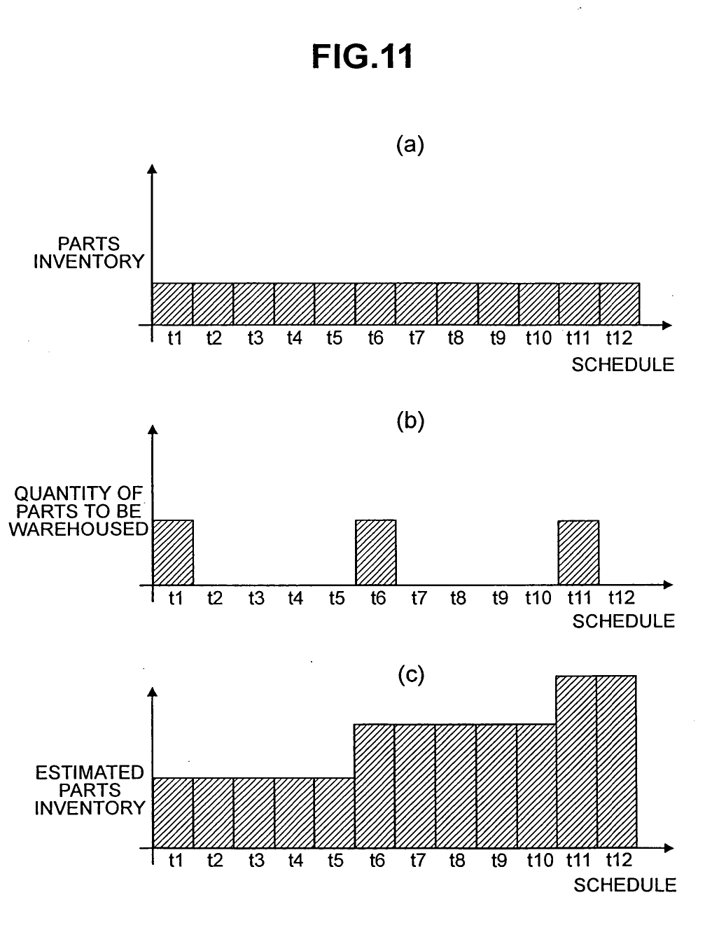

Step 1102 estimates the inventory schedule of each part type based on the above current parts inventory and parts delivery schedule. The inventory schedule is obtained by adding the quantity of parts to be warehoused to the current parts inventory over all time periods. FIG. 11 shows an example of this estimation. FIG. 11(a) shows the inventory quantity of the part c306. Specifically, the horizontal axis indicates each time period of the schedule, while the vertical axis indicates the inventory quantity, taking into no account the quantity of parts to be warehoused or retrieved. In FIG. 11(b), the horizontal axis indicates each time period of the schedule, while the vertical axis indicates the quantity of the parts c306 to be warehoused. Specifically, FIG. 11(b) indicates that parts will be warehoused in the time periods t1, t6, and t11. In FIG. 11(c), the horizontal axis indicates each time period of the schedule, while the vertical axis indicates the inventory quantity of the part c306 including the quantity of parts to be warehoused shown in FIG. 11(b).

Then, step 1103 starts a loop consisting the subsequent steps 1104 through 1114 to be repeated for each time period of the production schedule. The length of each time period for which the loop is repeated can be freely set by the operator. Then, step 1104 sets the initial planned product quantity to ∞. After that, step 1105 explodes a target model (product) into required part quantities based on the above information on a bill of materials.

Then, step 1106 starts a loop consisting of the subsequent steps 1107 through 1112 to be repeated for each component part type. Step 1107 determines whether the above exploded required part quantity for each component part type is larger than the estimated part inventory quantity for that component part type. If it is determined at step 1107 that the required part quantity is larger than the estimated part inventory quantity, the processing flow proceeds to step 1108. If it is determined that the required part quantity is not larger than the estimated part inventory quantity, on the other hand, the processing flow proceeds to step 1110.

Step 1108 checks whether parts of a target part type can be delivered in time if the order is newly issued at this time point.

If the parts can be delivered in time, the processing flow proceeds to step 1109.

If the parts cannot be delivered in time, the processing flow proceeds to step 1110. Step 1109 sets the quantity of parts of the target part type which can be procured to be equal to the required part quantity. Step 1110 sets the quantity of parts of the target part type which can be procured to be equal to the estimated part inventory quantity. Both steps 1109 and 1110 proceed to step 1111.

Step 1111 divides the procurable part quantity for the target part type by the number of parts of that part type constituting each product to obtain a part-basis producible product quantity for the target part type. Then, step 1112 updates the parts inventory schedule for all time periods after this time period. Specifically, step 1112 subtracts the estimated parts inventory for this time period from the estimated parts inventory for each time period after this time period and sets each result as the updated estimated parts inventory for a respective time period.

Step 1113 determines whether the loop consisting of steps 1107 through 1112 has been repeated for all component part types. If it is determined that the loop consisting of steps 1107 through 1112 has been repeated for all component part types, the processing flow proceeds to step 1114. If it is determined that the loop has not yet been repeated for all component part types, on the other hand, the processing flow returns to step 1106. Step 1114 selects the minimum value from among the part-basis producible product quantities as the producible product quantity.

Then, step 1115 determines whether the loop consisting of steps 1104 through 1114 has been repeated for all time periods of the production schedule. If it is determined that the loop consisting of steps 1104 through 1114 has been repeated for all time periods of the production schedule, the processing flow proceeds to step 1116. If it is determined that the loop has not yet been repeated for all time periods of the production schedule, the processing flow returns to step 1103. Step 1116 determines whether the loop consisting of steps 1102 through 1115 has been repeated for all retired models. If it is determined that the loop consisting of steps 1102 through 1115 has been repeated for all retired models, the processing flow ends. If it is determined that the loop has not yet been repeated for all retired models, the processing flow returns to step 1101.

As described above, by carrying out calculations for each model and each time period, it is possible to calculate the producible product quantity for each model in the case where all overstocked parts are assigned to the model. It should be noted that in addition to the above method in which a producible product quantity is calculated for each model, it is possible to employ a “priority-model-basis producible product quantity calculating method” comprising the steps of: giving priority to each retired model; calculating the producible product quantity for the retired model having the highest priority; and calculating the producible product quantity for the retired model having the second highest priority by use of the remaining parts (and so on). Furthermore, the producible product quantity for each retired model can be determined by using as an evaluation criterion an additional parts order quantity or gain and loss (described later) and employing a gradient method or a linear programming method such that the item selected as the evaluation criterion has a best value.

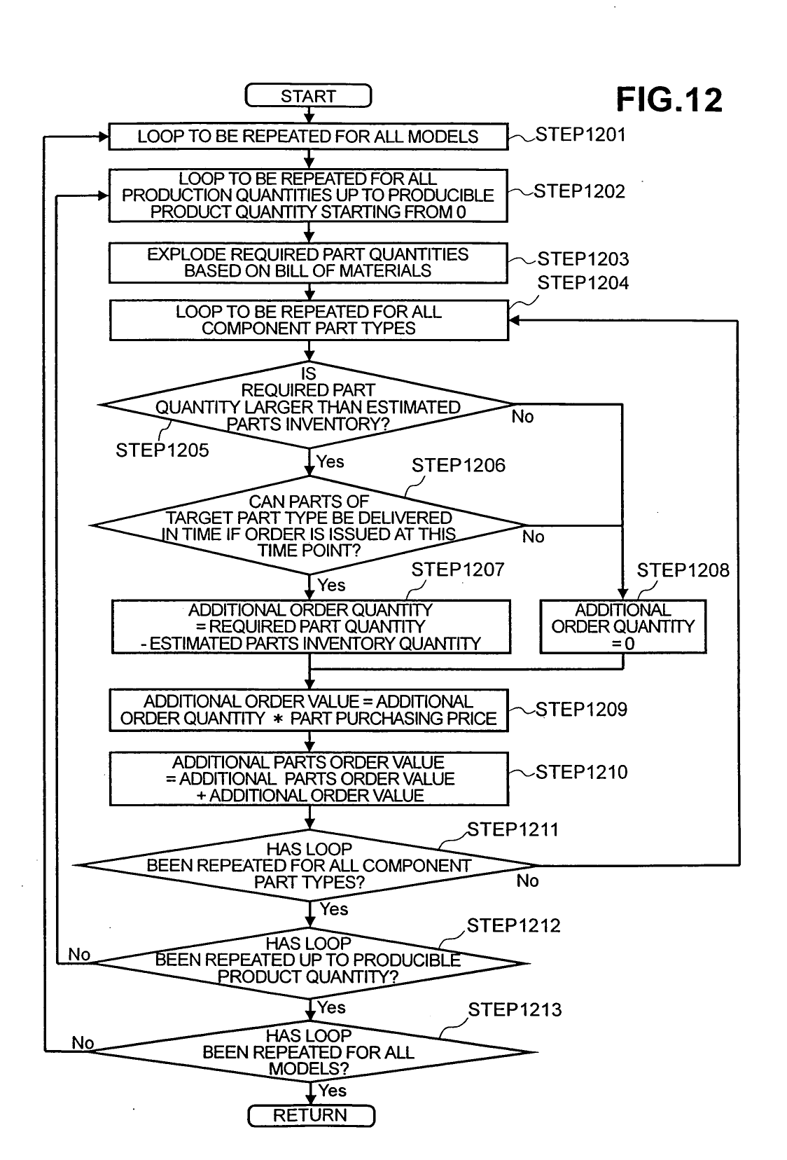

FIG. 12 shows the details of step 204. This step is performed by the additional parts order estimating section 118. First of all, step 1201 starts a loop consisting of the subsequent steps 1202 through 1213 to be repeated for all models. Step 1202 starts a loop consisting of the subsequent steps 1203 through 1211 to be repeated for every production quantity starting from 0 up to the producible product quantity calculated at step 203.

Step 1203 explodes a target production quantity of products into required part quantities based on the information on a bill of materials. Then, step 1204 starts a loop consisting of the subsequent steps 1205 through 1210 to be repeated for all component part types.

Step 1205 determines whether the required part quantity for a target component part type is larger than the (corresponding) estimated parts inventory quantity. If it is determined that the required part quantity for the target component part type is larger than the estimated parts inventory quantity, the processing flow proceeds to step 1206. If it is determined that the required part quantity for the target component part type is not larger than the estimated parts inventory quantity, on the other hand, the processing flow proceeds to step 1208. Step 1206 checks whether parts of the target part type can be delivered in time if the order is issued at this time point, that is, whether a new order for parts of the target part type can be placed. If the new order can be placed, the processing flow proceeds to step 1207. If the new order cannot be placed, on the other hand, the processing flow proceeds to step 1208. Step 1207 sets the additional order quantity to be equal to the required part quantity for the target part type minus the estimated part inventory quantity, and the processing flow proceeds to step 1209. Step 1208 sets the additional order quantity to 0, and the processing flow proceeds to step 1209. Step 1209 calculates the value of the additional order for the target part type based on the additional order quantity. The value of the additional order for the target part type is obtained by multiplying the additional order quantity by the purchasing price of the target part type. Then, step 1210 adds the value of the additional order for the target part type to the value of the additional parts order (the total additional order) so that after the loop has been repeated for all component part types, the value of the additional parts order for each production quantity can be obtained.

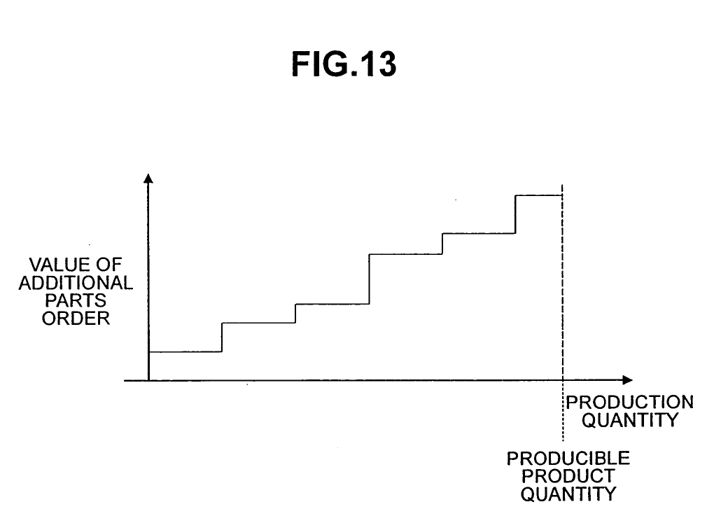

Then, step 1211 determines whether the loop consisting of steps 1205 through 1210 has been repeated for all component part types. If it is determined that the loop has been repeated for all component part types, the processing flow proceeds to step 1212. If it is determined that the loop has not yet been repeated for all component part types, on the other hand, the processing flow returns to step 1204. Step 1212 determines whether the loop consisting of steps 1203 through 1211 has been repeated for all possible production quantities. If it is determined that the loop has been repeated for all possible production quantities, the processing flow proceeds to step 1213. If it is determined that the loop has not yet been repeated for all possible production quantities, the processing flow returns to step 1202. Step 1213 determines whether the loop consisting steps 1202 through 1212 has been repeated for all models. If it is determined that the loop has been repeated for all models, the processing flow ends. If it is determined that the loop has not yet been repeated for all models, on the other hand, the processing flow returns to step 1201. A result from the above processing is shown in FIG. 13. In the figure, the horizontal axis indicates the production quantity, while the vertical axis indicates the value of the additional parts order.

Then, step 205 determines a quantity to be added to the planned production quantity based on the value of the additional parts order for each model obtained at step 204. This determination may be made by the operator interactively with the above operator input/output apparatus 102. Or alternatively, based on the value of the additional parts order for each model, the above retired parts disposal section 120 may determine a production quantity at which the value of the additional parts order is minimized. An example of determination made interactively by the operator will be described later. The determined planned production quantity is supplied to step 206. Step 206 determines whether any addition has been made to the original planned production quantity.

If it is determined that some addition has been made to the planned production quantity, the processing flow returns to step 202. If it is determined that no addition has been made to the planned production quantity, on the other hand, the processing flow ends. Step 202 includes the steps of: when overstocked parts are estimated, exploding a quantity of products equal to the above quantity added to the planned production quantity at step 205 based on the information on a bill of materials; and subtracting the resultant required part quantity for the additional production plan from the surplus part quantity to obtain overstocked parts (quantity) after the above addition to the production plan.

As described above, steps 202 through 206 are repeated, and then evaluation is made by use of the value of the additional parts order calculated at step 204 to determine a retired model production plan and the number of parts to be sold (for each part type). With this arrangement, it is possible to dispose of the retired parts inventory and retired parts to be warehoused with a minimum of the value of the additional parts order.

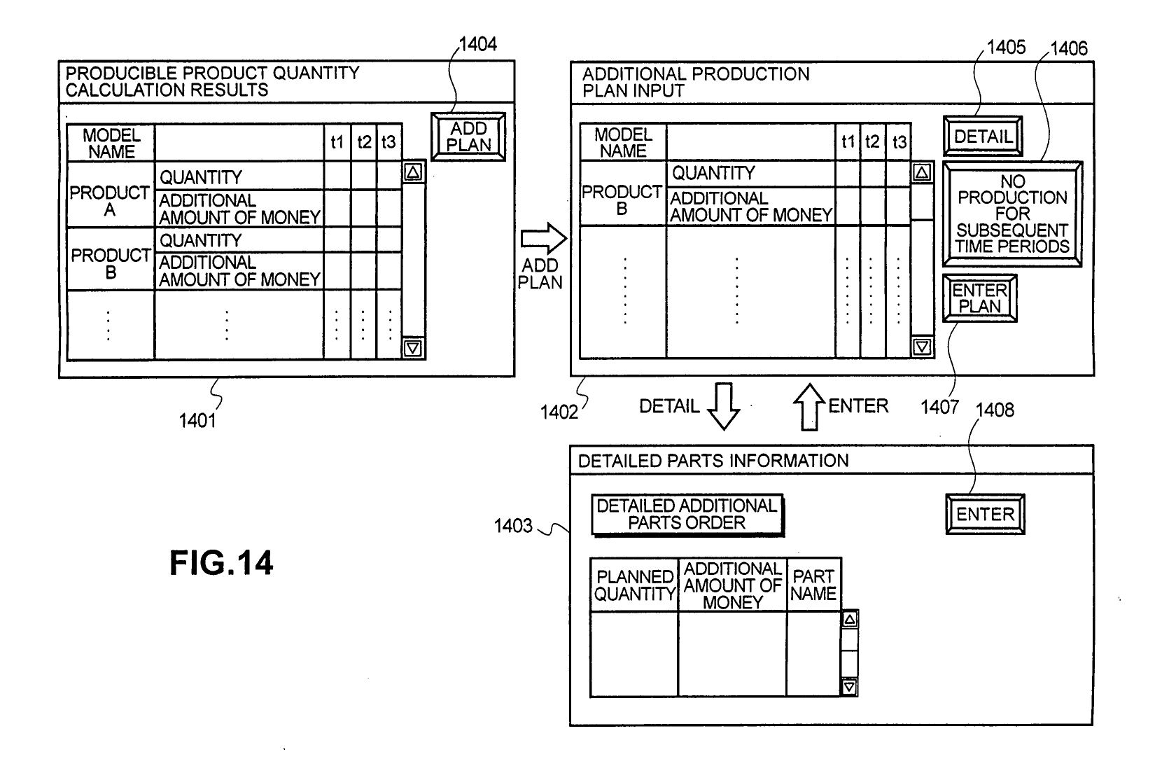

Description will be made below of an example in which the operator (planner) interactively drafts a production plan for a retired model with reference to FIG. 14.

First, a producible product quantity calculation results screen 1401 is displayed to the planner. This screen indicates the producible product quantity for each model in each time period and the value of the corresponding additional (parts) order. On the screen, the planner selects a model whose production plan is to be drafted by comparing the selling prices of models to one another. If the operator (planner) selects a field of a target model by use of a mouse or a keyboard and further selects an Add Plan button 1404 by use of a mouse or a keyboard, the producible product quantity for the target model in each time period and the value of the corresponding additional (parts) order are copied to an additional production plan input screen 1402.

On the additional production plan input screen 1402, the field to which the producible product quantity for the target model in each time period is copied is referred to as an additional production plan field. On the additional production plan input screen 1402, as an additional production plan, the planner enters a value, which is smaller than a respective producible product quantity, in the additional production plan field of each model for each time period by use of a mouse or a keyboard. When determining the value, if the planner selects the additional production plan field of a target model for a target time period by use of a mouse or a keyboard and further selects a Detail button 1405 by use of a mouse or a keyboard, a detailed parts information screen 1403 is displayed.

The detailed parts information screen 1403 displays, for each (possible) production quantity, the names of parts to be additionally ordered for the target model in the target time period and the value of the order. The planner checks each production quantity, the names of parts to be additionally ordered, the value of the order, and the selling price of the product, and selects a desired production quantity by use of a mouse or a keyboard. After selecting the desired product quantity, if the planner selects an Enter button 1408 by use of a mouse or a keyboard, the selected product quantity (for the production plan) is copied to the production quantity field (the additional production plan field) of the target model for the target time period on the additional production plan input screen 1402. On the other hand, if the planner does not want to produce any products of the target model in the target and subsequent time periods, the planner selects the production quantity field of the target model for the target time period on the additional production plan input screen 1402 by use of a mouse or a keyboard and further selects a “No Production For Subsequent Time Periods” button 1406 by use of a mouse or a keyboard to set a value of 0 for the production quantity fields of the target model for the target time period and all the subsequent time periods on the additional production plan input screen 1402.

After drafting a final retired model production plan by repeating the above operation for each model, the planner selects an Enter Plan button 1407 on the additional production plan input screen 1402 by use of a mouse or a keyboard to decide an additional production plan for each retired model.

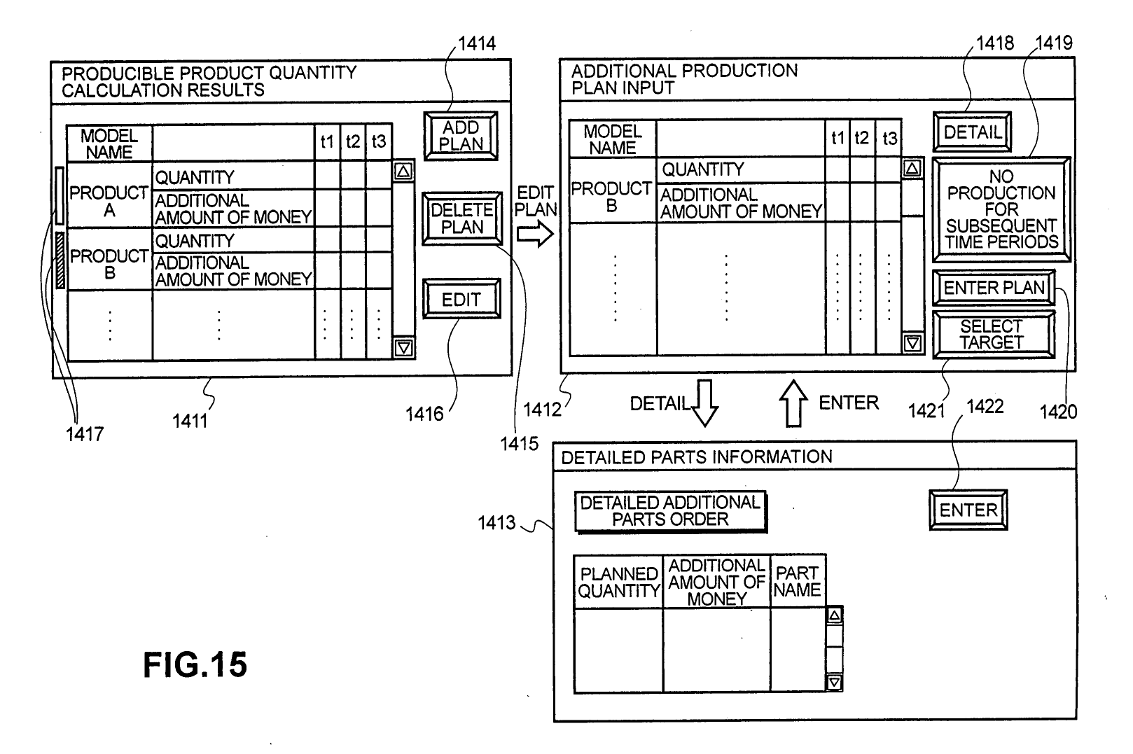

Description will be made below of another example in which the operator (planner) also interactively drafts a production plan for a retired model with reference to FIG. 15.

First, a producible product quantity calculation results screen 1411 is displayed to the planner. This screen indicates the producible product quantity for each model in each time period and the value of the corresponding additional (parts) order. Furthermore, a Check button 1417 is provided for each model on the screen. On the screen, the planner selects a model whose production plan is to be drafted by comparing the selling prices of models to one another. If the planner selects a field of a desired model on the screen by use of a mouse or a keyboard and further selects an Add Plan button 1414 by use of a mouse or a keyboard, the model is selected as a target whose additional production plan is to be drafted, and the corresponding Check button 1417 is selected (as indicated in black in the figure). On the other hand, if the planner selects a field of the desired model on the screen by use of a mouse or a keyboard and further selects a Delete Plan button 1415 by use of a mouse or a keyboard, the model is deselected and is no longer a target whose additional production plan is to be drafted, and the corresponding Check button 1417 is deselected (as indicated in white in the figure). If the planner selects an Edit button 1416 by use of a mouse or a keyboard, the producible product quantity (for each time period) of the model whose Check button 1417 has been selected and the value of the corresponding additional (parts) order are copied to an additional production plan input screen 1412.

On the additional production plan input screen 1412, the field to which the producible product quantity for the target model in each time period is copied is referred to as an additional production plan field. On the additional production plan input screen 1412, as an additional production plan, the planner enters a value, which is smaller than a respective producible product quantity, in the additional production plan field of each model for each time period by use of a mouse or a keyboard. When determining the value, if the planner selects the additional production plan field of a target model for a target time period by use of a mouse or a keyboard and further selects a Detail button 1418 by use of a mouse or a keyboard, a detailed parts information screen 1413 is displayed.

The detailed parts information screen 1413 displays, for each (possible) production quantity, the names of parts to be additionally ordered for the target model in the target time period and the value of the order. The planner checks each production quantity, the names of parts to be additionally ordered, the value of the order, and the selling price of the product, and selects a desired product production quantity by use of a mouse or a keyboard. After selecting the desired product production quantity, if the planner selects an Enter button 1422 by use of a mouse or a keyboard, the selected production quantity (for the production plan) is copied to the production quantity field (the additional production plan field) of the target model for the target time period on the additional production plan input screen 1412. On the other hand, if the planner does not want to produce any products of the target model in the target and subsequent time periods, the planner selects the production quantity field of the target model for the target time period on the additional production plan input screen 1412 by use of a mouse or a keyboard and further selects a “No Production For Subsequent Time Periods” button 1419 by use of a mouse or a keyboard to set a value of 0 for the production quantity fields of the target model for the target time period and all the subsequent time periods on the additional production plan input screen 1412.

After drafting a final retired model production plan by repeating the above operation for each model, the planner selects an Enter Plan button 1420 on the additional production plan input screen 1412 by use of a mouse or a keyboard to decide an additional production plan for each retired model. On the additional production plan input screen 1412, if the planner wants to change the model selected as the target whose additional production plan is to be drafted, the planner selects a Select Target button 1421 by use of a mouse or a keyboard. Since selecting the Select Target button 1421 displays the producible product quantity calculation results screen 1411, the planner can change the model selected as the target whose additional production plan is to be drafted, as described above.

Description will be made below of a variation of the above example described with reference to FIGS. 1 to 15. In this example, no production plan (information) has been promised to the outside, and therefore it can be assumed that all models to be produced are retired models. In such a case, both the required parts explosion processing at step 201 and the overstocked parts extraction processing at step 202 shown in FIG. 2 may be omitted. The retired parts estimating section 116 may set both the parts inventory information stored in the parts inventory information storage section 106 and the parts delivery schedule stored in the parts delivery schedule storage section 107 as information on parts used for only retired models. Then, the producible product quantity calculating section 117 may calculate the producible product quantity for each retired model.

Description will be made below of another variation of the above example described with reference to FIGS. 1 to 15. In this example, a production plan (information) has already been promised to the outside, and therefore it is necessary to execute the production plan even if it is of a retired model. In such a case, in the required parts explosion processing at step 201 shown in FIG. 2, the MRP explosion apparatus 115 may treat the production plan of a retired model whose production has been promised, as that of a current model.

Description will be made below of still another variation of the above example described with reference to FIGS. 1 to 15. In this example, a production plan of a new model is stored as production planning information. In such a case, in the required parts explosion processing at step 201 shown in FIG. 2, the MRP explosion apparatus 115 may treat the production plan of a new model as that of a current model.

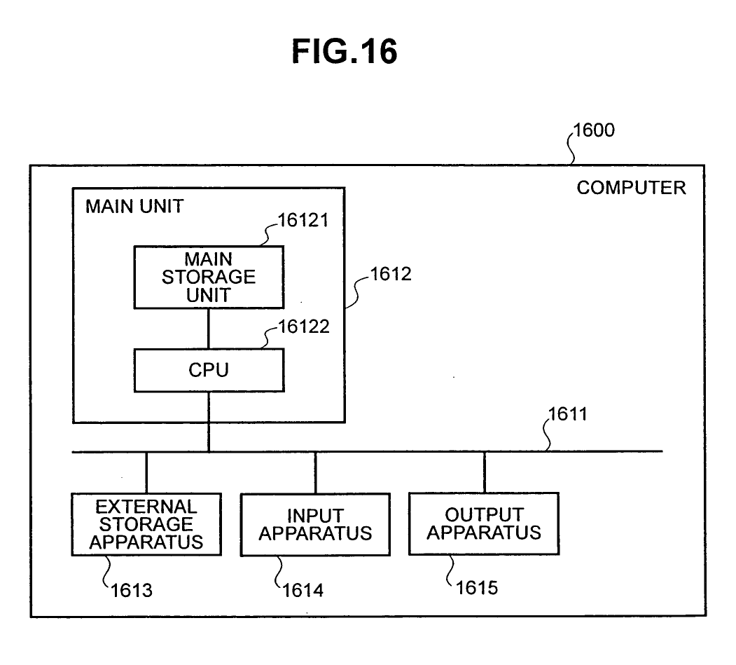

FIG. 16 shows the hardware configuration of the master production scheduling system 100 shown in FIG. 1.

In the figure, a computer 1600 comprises: a bus 1611; a main unit 1612 connected to the bus 1611; an external storage apparatus 1613 connected to the bus 1611; an input apparatus 1614 connected to the bus 1611; and an output apparatus 1615 connected to the bus 1611. The main unit 1612 includes a main storage unit 16121 and a CPU (Central Processing Unit) 16122.

In the computer 1600, the main storage unit 16121 stores various programs and data necessary to execute these programs. The CPU 16122 executes a program stored in the main storage unit 16121 using data stored in the main storage unit 16121. The external storage apparatus 1613 may have a capacity larger than that of the main storage unit 16121. Programs and data to be stored in the main storage unit 16121 may be stored in the external storage apparatus 1613, and then read out from the external storage apparatus 1613 into the main storage unit by the CPU 16122 as necessary. As the external storage apparatus 1613, it is possible to use a floppy disk, which is a portable medium, a CD-ROM (Compact Disk Read-Only Memory), etc. in addition to a hard disk device.

In the computer 1600, the input apparatus 1614 is made up of an input control section (not shown) and an input section (not shown), such as a mouse or a keyboard, connected to the input control section. The input apparatus 1614 receives information entered by the operator by use of the input section such as a mouse or a keyboard. The output apparatus 1615 is made up of an output control section (not shown) and an output section (not shown), such as a display or a printer, connected to the output control section. The output apparatus 1615 can output to the output section, such as a display or a printer, data read from the external storage apparatus 1613 into the main storage unit 16121 by the CPU 16122. The output apparatus 1615 also can output a program execution result by the CPU 16122 to the output section such as a display or a printer.

Each apparatus in FIG. 1 described above is implemented by the components in FIG. 16 as follows.

The external storage apparatus 1613 realizes a function of the following sections in the data storage apparatus 101 to permanently store temporarily-held information: the production planning information storage section 104, the information on a bill of materials storage section 105, the parts inventory information storage section 106, the parts delivery schedule storage section 107, the parts purchasing price information storage section 108, and the retired model information storage section 109. The main storage unit 16121 on the other hand, realizes another function of the above sections in which the operator refers to or updates stored information, or the operator registers new information.

The MRP explosion apparatus 115 and the retired parts estimating section 116, the producible product quantity calculating section 117, the additional parts order estimating section 118, and the retired parts disposal section 120 all included in the “retired model overstocked parts disposal method determining” apparatus 103 are implemented by performing the steps of: storing into the external storage apparatus 1613 programs designed to carry out the operations of the above apparatuses and sections; reading these programs from the external storage apparatus 1613 into the main storage unit 16121; and executing the programs by use of the CPU 16122. When interactively drafting a production plan of a retired model, the operator can enter an instruction from the input apparatus 1614 while displaying the display screens as shown in FIGS. 14 and 15 in the output apparatus 1615 so that the production plan is drafted based on the entered instruction.

The operator input/output apparatus 102 is implemented by the input apparatus 1614 and the output apparatus 1615.

It should be noted that the following hardware configuration, which is a variation of the above hardware configuration, may be employed. A plurality of computers are connected to one another such that they can exchange data. With this arrangement, the MRP explosion apparatus 115 and the “retired model overstocked parts disposal method determining apparatus” 1503 may be each implemented by a separate computer.

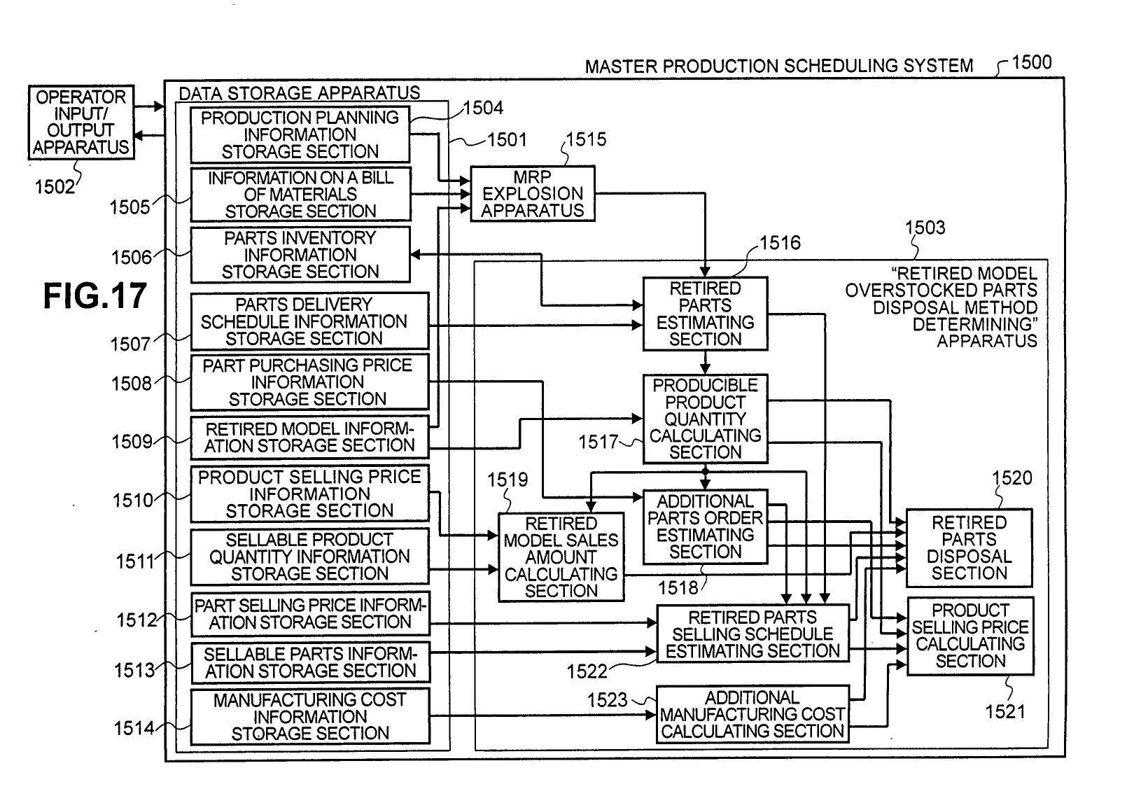

FIG. 17 shows another functional configuration of the master production scheduling system according to the present invention. As shown in FIG. 17, the master production scheduling system 1500 of the present invention comprises an MRP explosion apparatus 1515, a “retired model overstocked parts disposal method determining apparatus” 1503, and a data storage apparatus 1501. It should be noted that the master production scheduling system 1500 may comprise an operator input/output apparatus 1502.

The above data storage apparatus 1501 comprises: a production planning information storage section 1504 for storing production plans drafted beforehand; a information on a bill of materials storage section 1505 for storing a component parts list for each product; a parts inventory information storage section 1506 for storing the current inventory state of each part; a parts delivery schedule storage section 1507 for storing a delivery schedule on each ordered part, a parts purchasing price information storage section 1508 for storing an estimated unit purchasing price of each part to be purchased in the future; a retired model information storage section 1509 for storing the names of retiring (retired) product models; a product selling price information storage section 1510 for storing an estimated selling price of each product model; a sellable product quantity information storage section 1511 for storing a sellable product quantity for each retired model on which the sales division agrees; a parts selling price information storage section 1512 for storing an estimated selling price of each part; a sellable parts information storage section 1513 for storing an estimated sellable part quantity for each part type to be sold in the future; and a manufacturing cost information storage section 1514 for storing the manufacturing cost of each product. An example of how data stored by each section within the data storage apparatus 1501 is displayed on the operator input/output apparatus 1502 will be described later.

The above MRP explosion apparatus 1515 carries out MRP explosion. “MRP” is an abbreviation for “material resource planning”, indicating estimation of gross requirements. An MRP explosion process obtains the name of parts and their quantity needed to produce each product according to a production plan stored in the above production planning information storage section 1504 and the time periods in which the parts should be procured by referring to the component parts list and the production lead time of each product stored in the above information on a bill of materials storage section 1505.

The above “retired model overstocked parts disposal method determining” apparatus 1503 comprises: a retired parts estimating section 1516 for estimating the parts inventory and the parts delivery schedule for a retired model based on the output of the MRP explosion apparatus 1515; a producible product quantity calculating section 1517 for calculating a producible product quantity for the retired model based on the above parts inventory and parts delivery schedule for the retired model; an additional parts order estimating section 1518 for estimating parts to be additionally ordered and the amount of money to be paid for them (the value of the additional parts order) when a quantity of products of the retired model equal to the producible product quantity are produced; a retired model-sales amount estimating section 1519 for calculating the amount of sales obtained when a quantity of products of the retired model equal to the producible product quantity are sold; a retired parts selling schedule estimating section 1522 for calculating the estimated quantity of retired parts to be sold after a quantity of products of the retired model equal to the producible product quantity are produced and the estimated amount of sales of the retired parts; an additional manufacturing cost calculating section 1523 for calculating an additional manufacturing cost incurred when a quantity of products of the retired model equal to the producible product quantity are produced; a retired parts disposal section 1520 for clearing out the above retired parts inventory and retired parts delivery schedule such that entire loss is reduced based on the producible product quantity for the retired model, the additional parts-order, the amount of the sales of retired model products, the retired parts selling schedule, and the additional manufacturing cost; and a product selling price calculating section 1521 for calculating the selling price of the retired model to clear out the retired parts inventory and retired parts delivery schedule such that the entire loss is reduced based on the producible product quantity for the retired model, the additional parts order, the retired parts selling schedule, and the additional manufacturing cost.

The operator input/output apparatus 1502 can indicate to the operator data stored in each section of the data storage-apparatus 1501. The operator input/output apparatus 1502 can receive information for updating the data stored in each section of the data storage apparatus 1501. Furthermore, when the operator drafts a production plan for a retired model in an interactive manner, the operator input/output apparatus 1502 can display a screen for helping draft the plan.

The master production scheduling system 1500 also includes programs used for processing for indicating data to the operator input/output apparatus 1502, input data processing, etc.

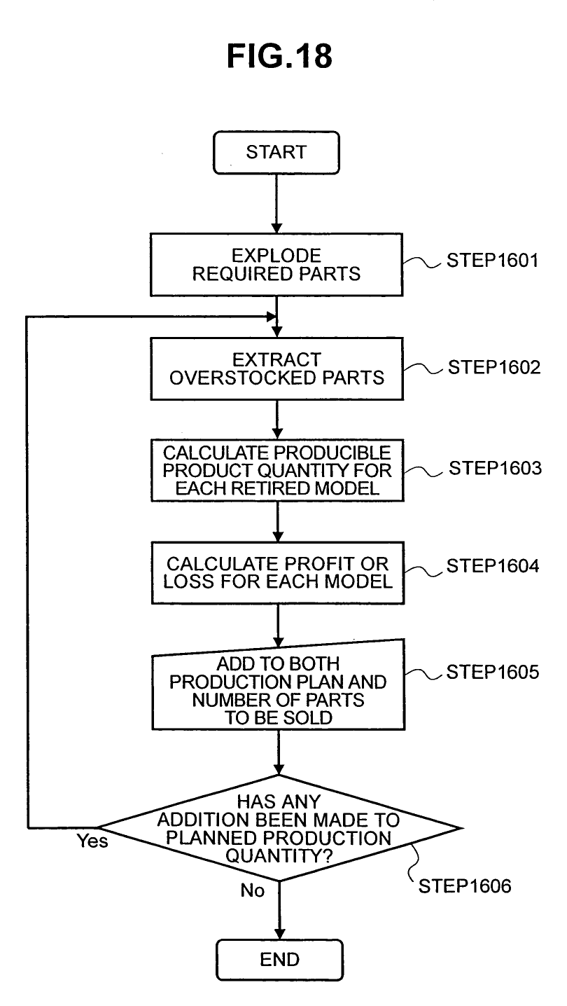

FIG. 18 shows a production plan adjustment algorithm according to the present invention. This algorithm realizes the above “retired model overstocked parts disposal method determining” apparatus 1503.

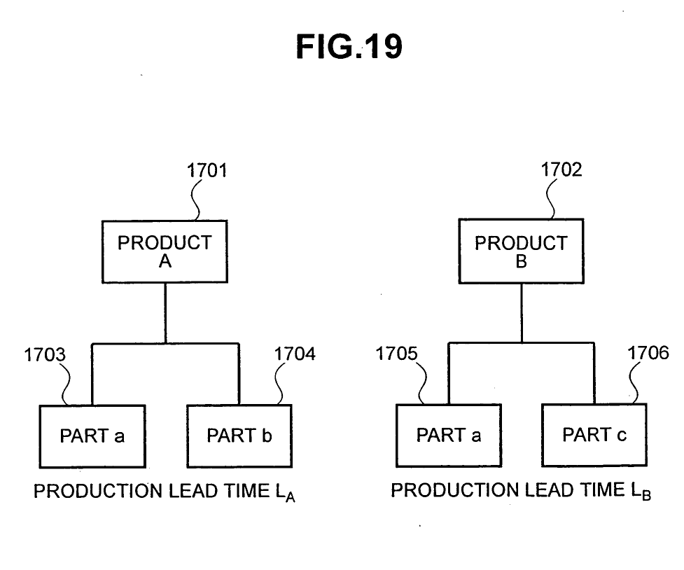

With reference to FIGS. 18 and 20 to 35, description will be made below of a production plan adjustment according to an embodiment of the present invention by use of products A1701 and B1702 whose component parts lists are shown in FIG. 19. Thus, two types of products, namely product types A and B, are used as examples. The product A1701 is made up of parts a1703 and b1704. Reference numeral L_{A} denotes a production lead time required for manufacturing the product A1701 from the parts a1703 and b1704. The product B1702, on the other hand, is made up of parts a1705 and c1706. Reference numeral L_{B} denotes a production lead time required for manufacturing the product B1702 from the parts a1705 and c1706. The parts a1703 and a1705 are common parts between the products A1701 and B31702. This information is stored in the information on a bill of materials storage section 1505 in the data storage apparatus 1501. It should be noted that each figure indicates data in a state in which the data is displayed on the operator input/output apparatus 1502 for convenience even though the data is stored in a different form. Thus, in the present invention, the data configuration of information stored in the data storage apparatus 1501 is indicated in a form in which the information (data) is displayed on the screen of the operator input/output apparatus 1502.

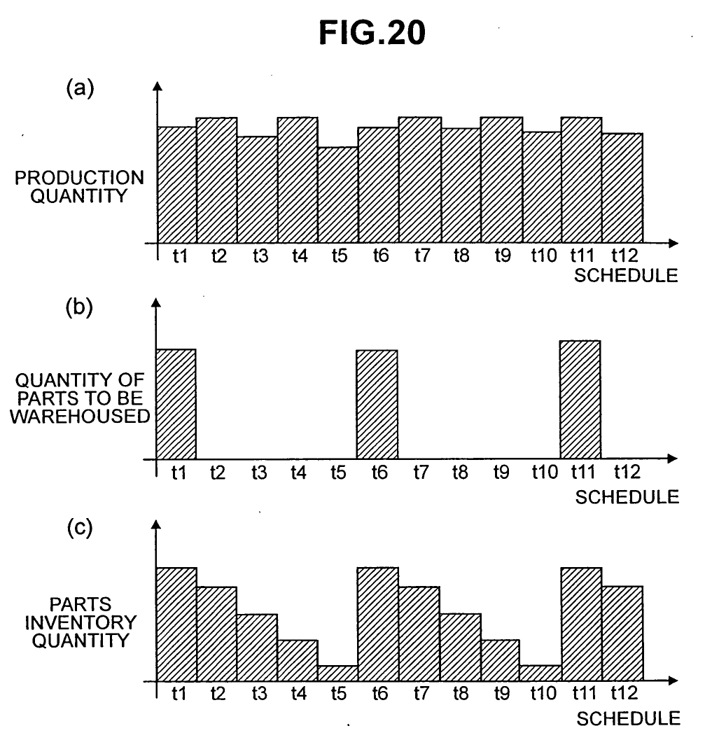

FIG. 20(a) shows an example of production planning information stored in the production planning information storage section 1504 in the data storage apparatus 1501. Specifically, FIG. 20(a) indicates the production plan of the product A1701, wherein the horizontal axis indicates each time period of the schedule and the vertical axis indicates the number of products A1701 to be completed for each time period.

FIG. 20(b) shows an example of a parts delivery schedule stored in the parts delivery schedule storage section 1507 in the data storage apparatus 1501. Specifically, FIG. 20(b) indicates the parts delivery schedule of the part a1703 of the product A1701, wherein the horizontal axis indicates each time period of the parts delivery schedule and the vertical axis indicates the quantity of the parts a1703 to be warehoused.

FIG. 20(c) shows an example of parts inventory information stored in the parts inventory information storage section 1506 in the data storage apparatus 1501. Specifically, FIG. 20(c) indicates the parts inventory of the part a1703 of the product A1701, wherein the horizontal axis indicates each time period of the schedule and the vertical axis indicates the total inventory (the number of warehoused parts minus the number of retrieved parts).

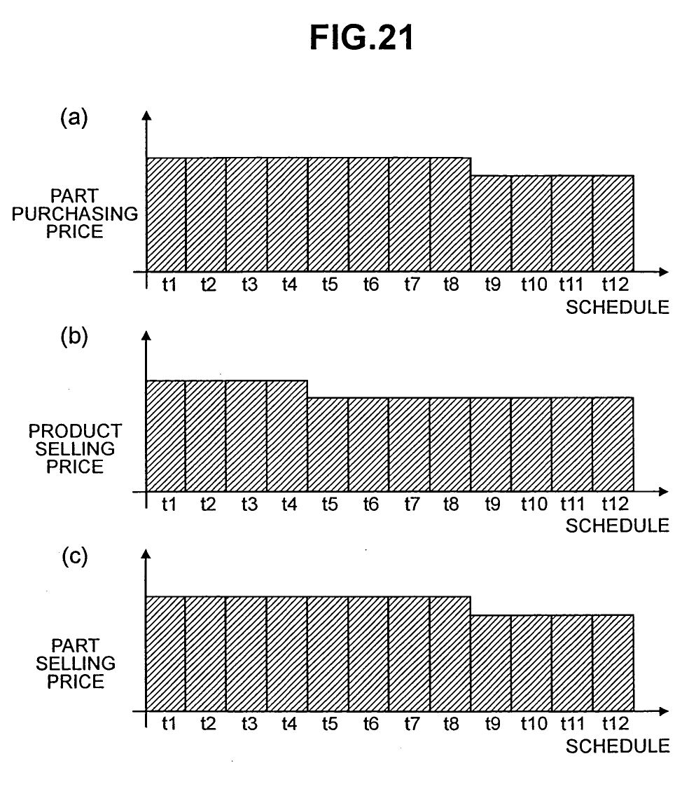

FIG. 21(a) shows an example of parts purchasing price information stored in the parts purchasing price information storage section 1508 in the data storage-apparatus 1501. Specifically, FIG. 21(a) indicates changes in the parts purchasing price of the part a1703 of the product A1701, wherein the horizontal axis indicates each time period of the parts delivery schedule and the vertical axis indicates the purchasing price of the part.

FIG. 21(b) shows an example of product selling price information stored in the product selling price information storage section 1510 in the data storage apparatus 1501. Specifically, FIG. 21(b) indicates changes in the product selling price of the product A1701, wherein the horizontal axis indicates each time period of the product order acceptance schedule and the vertical indicates the selling price of the product.

FIG. 21(c) shows an example of parts selling price information stored in the parts selling price information storage section 1513 in the data storage apparatus 1501. Specifically, FIG. 21(c) indicates changes in the parts selling price of the part a1703 of the product A1701, wherein the horizontal axis indicates each time period of the parts selling schedule and the vertical axis indicates the selling price of the part.

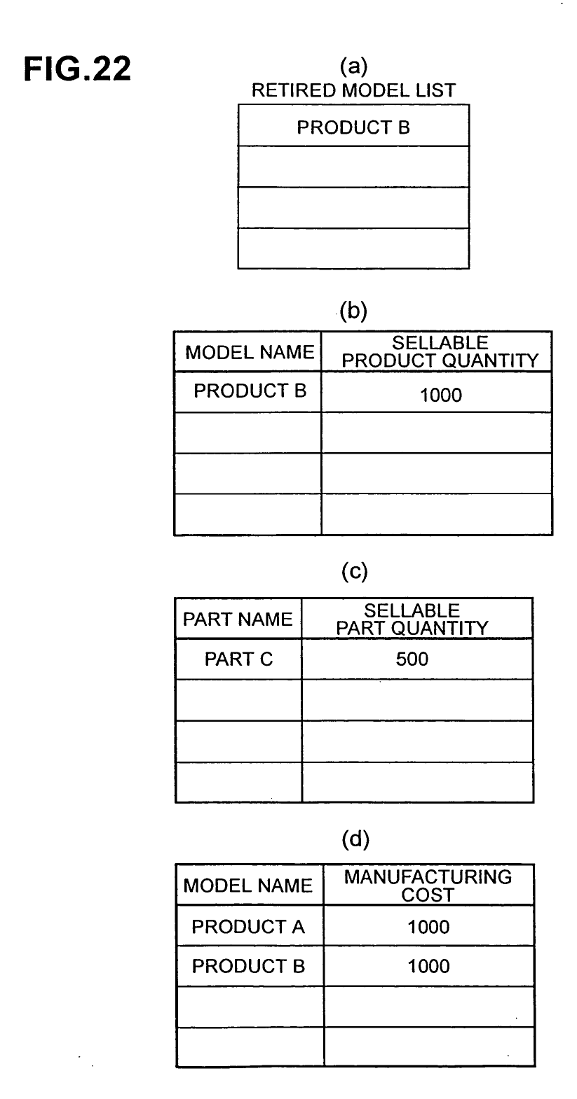

FIG. 22(a) shows an example of retired model information stored in the retired model information storage section 1509 in the data storage apparatus 1501. In this example, the product B1702 is registered as a retired model.

FIG. 22(b) shows an example of sellable product quantity information stored in the sellable product quantity information storage section 1511 in the data storage apparatus 1501. In this example, the estimated sellable product quantity for the product B1702, which is a retired model, is registered.

FIG. 22(c) shows an example of sellable part quantity information stored in the sellable parts information storage section 1513 in the data storage apparatus 1501. In this example, the estimated sellable quantity of the parts c1706, which are used in only the product B1702, is registered.

FIG. 22(d) shows an example of product manufacturing cost information stored in the manufacturing cost information storage section 1514 in the data storage apparatus 1501. In this example, the manufacturing costs of the products A1701 and B1702 are registered.

Description will be made below of production plan adjustment carried out by a production plan adjustment system of the present invention with reference to accompanying drawings. FIG. 18 schematically shows a production plan adjustment method.

As shown in FIG. 18, based on a predetermined production plan, the production plan adjustment system of the present invention explodes a product into required quantities of parts at step 1601 and extracts overstocked parts based on the exploded required part quantities at step 1602. Step 1603 calculates the number of products which can be produced (producible product quantity) for each retired model based on the overstocked parts extracted at step 1602. Step 1604 calculates profit or loss for each quantity of products of each model based on the producible product quantity for each retired model calculated at step 1603. Step 1605 determines a production quantity and the quantity of parts to be sold for each retired model and adds them to the production plan based on the profit or loss for each quantity of products of each model obtained at step 1604. Step 1606 determines whether any addition has been made to the planned production quantity at step 1605. If it is determined that any addition has been made to the planned production quantity, the process returns to step 1602. If it is determined that no addition has been made to the planned production quantity, on the other hand, the process ends.

Steps 1602 through 1606 are repeated so as to finally determine a production quantity and the quantity of parts to be sold for each retired model.

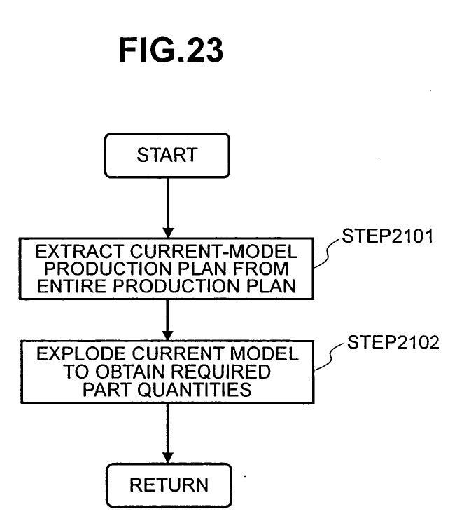

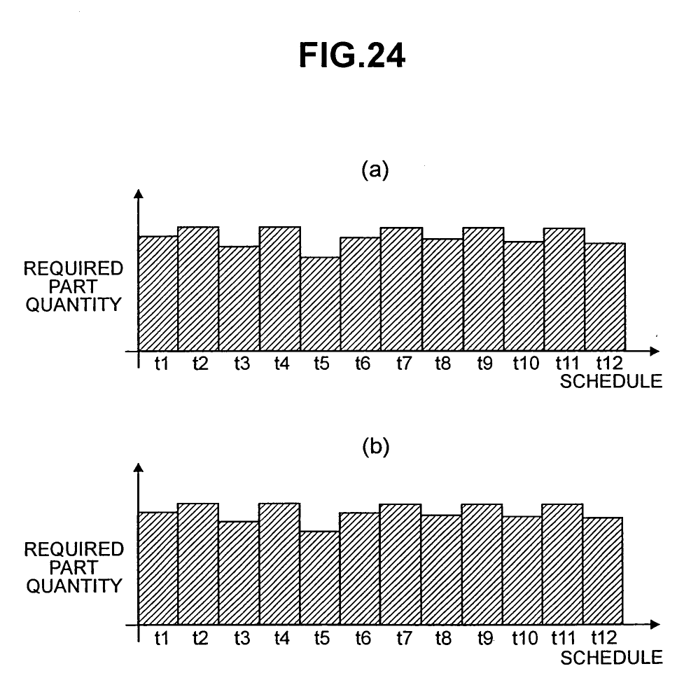

FIG. 23 shows the de-tails of step 1601, which is carried out by the MRP explosion apparatus 1515. First of all, step 2101 extracts a current-model production plan based on the above production planning information and retired model information. In this example, the retired model is the product B as indicated in FIG. 22. Therefore, the current-model production plan is obtained as a result of removing the plan of the product B from the entire production plan. The current-model production plan is indicated by FIG. 20(a). Step 2102 calculates required part quantities for the current model based on the above information on a bill of materials and current-model production plan. Specifically, from a parts list, step 2102 estimates each part type and its quantity required for producing the quantity of products (of each model) specified by the production plan. In the example of FIG. 19, 50 parts a1703 and 50 parts b1704 are needed to manufacture 50 products A1701. As described above, since a production plan is a schedule indicating time periods (intervals) and the quantity of products to be completed in each time period, the required quantities of the parts a1703 and b1704 for each time period are calculated based on the production plan of the product A, considering each production lead time. The required quantities of the parts a1703 and b704 are calculated as indicated by FIGS. 24(a) and 24(b). In each figure, the horizontal axis indicates each time period of the schedule in which parts are needed, while the vertical axis indicates the required quantity of the parts.

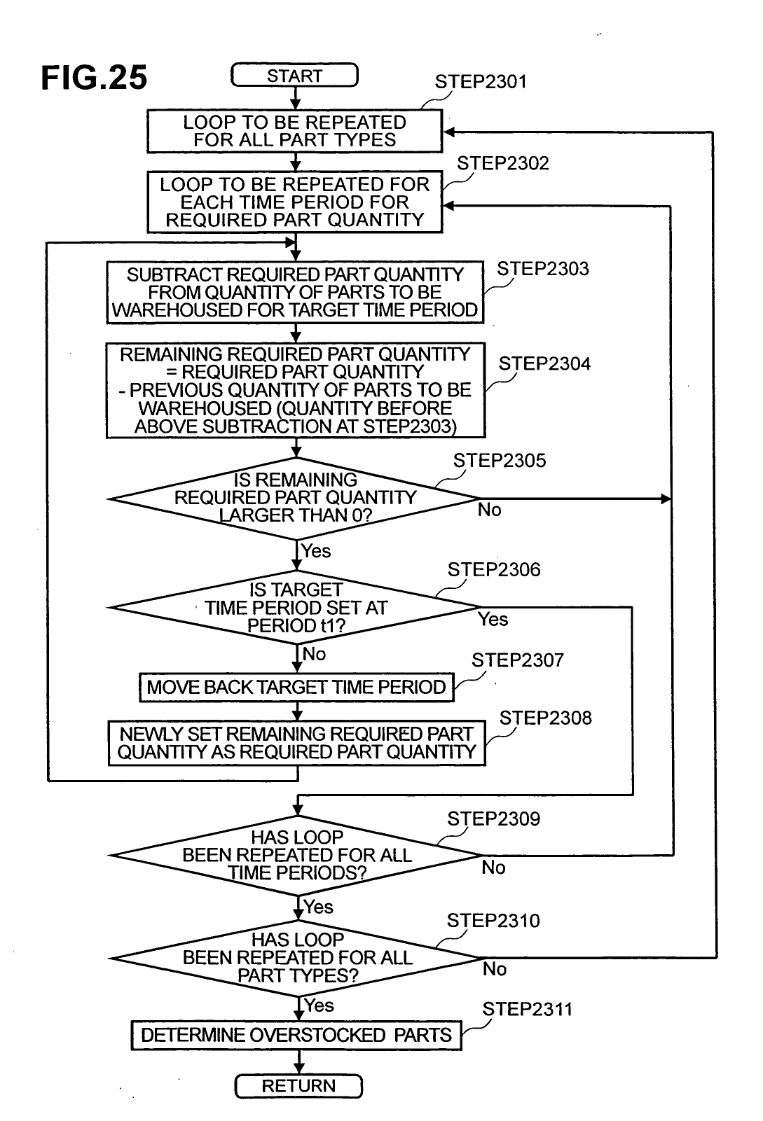

FIG. 25 shows the details of step 1602. Step 1602 is carried out by the above retired parts estimating section 1516. First of all, step 2301 starts a loop consisting of the subsequent steps 2302 through 2309 to be repeated for all part types. The next step 2302 starts another loop consisting of the subsequent steps 2303 through 2308 to be repeated for each time period in which parts are needed.

For a target part type and in a target time period, step 2303 subtracts the required part quantity from the quantity of parts to be warehoused. However, if the target time period is the time period t1 in the figure, step 2303 subtracts the required part quantity from the sum of the inventory (quantity) up to that time period and the quantity of parts to be warehoused. At that time, when the required part quantity is larger than the quantity of parts to be warehoused, step 2303 subtracts only a part quantity equal to the quantity of parts to be warehoused.

Then, step 2304 subtracts the quantity of parts to be warehoused (which is the quantity before the above subtraction at step 2303) from the required part quantity to produce a remaining required part quantity. The remaining required part quantity indicates the part quantity by which the required part quantity exceeds the quantity of parts to be warehoused. (for the target part type in the target time period).

Then, step 2305 checks whether the remaining required part quantity is larger than 0. If it is not larger than 0, the processing flow proceeds to step 2302, and the required part quantity for the next time period is subtracted. If the remaining required part quantity is larger than 0, on the other hand, the processing flow proceeds to step 2306.

Step 2306 determines whether the target time period in which parts are needed is the time period t1. If it is determined that the target time period is the time period t1, the processing flow proceeds to step 2309. If it is determined that the target time period is not the time period t1, on the other hand, the processing flow proceeds to step 2307.

Step 2307 moves back the target time period to the previous time period (for the remaining required part quantity). For example, if the required part quantity is larger than the quantity of parts to be warehoused in the time period t5, the processing flow proceeds to a step at which the remaining required part quantity is subtracted from the quantity of parts to be warehoused in the time period t4. Then, step 2308 newly sets the remaining required part quantity as the required part quantity, and the processing flow proceeds to step 2309.

Step 2309 determines whether steps 2303 through 2308 have been repeated for all time periods of the schedule to process the required part quantities. If it is determined that the steps have not yet been repeated for all time periods to process the required part quantities, the processing flow returns to step 2302. If it is determined that the steps have been repeated for all time periods to process the required part quantities, the processing flow proceeds to step 2310.

Step 2310 determines whether steps 2302 through 2309 have been repeated for all part types. If it is determined that the steps have not yet been repeated for all part types, the processing flow returns to 2301. If it is determined that the steps have been repeated for all part types, the processing flow proceeds to step 2311.

Step 2311 sets as an overstocked parts quantity the quantity of parts to be warehoused for each time period from which any required part quantity have not been subtracted (or, for the time period t1, the sum of the inventory up to that time period and the quantity of parts to be warehoused for that time period), and the processing flow ends.

As described above, steps 2303 through 2308 are repeated so as to subtract each required part quantity from the quantity of parts to be warehoused in the corresponding time period and thereby calculate the quantity of parts to be warehoused which are not be used for a current model, that is, the (quantity of) overstocked parts to be warehoused.

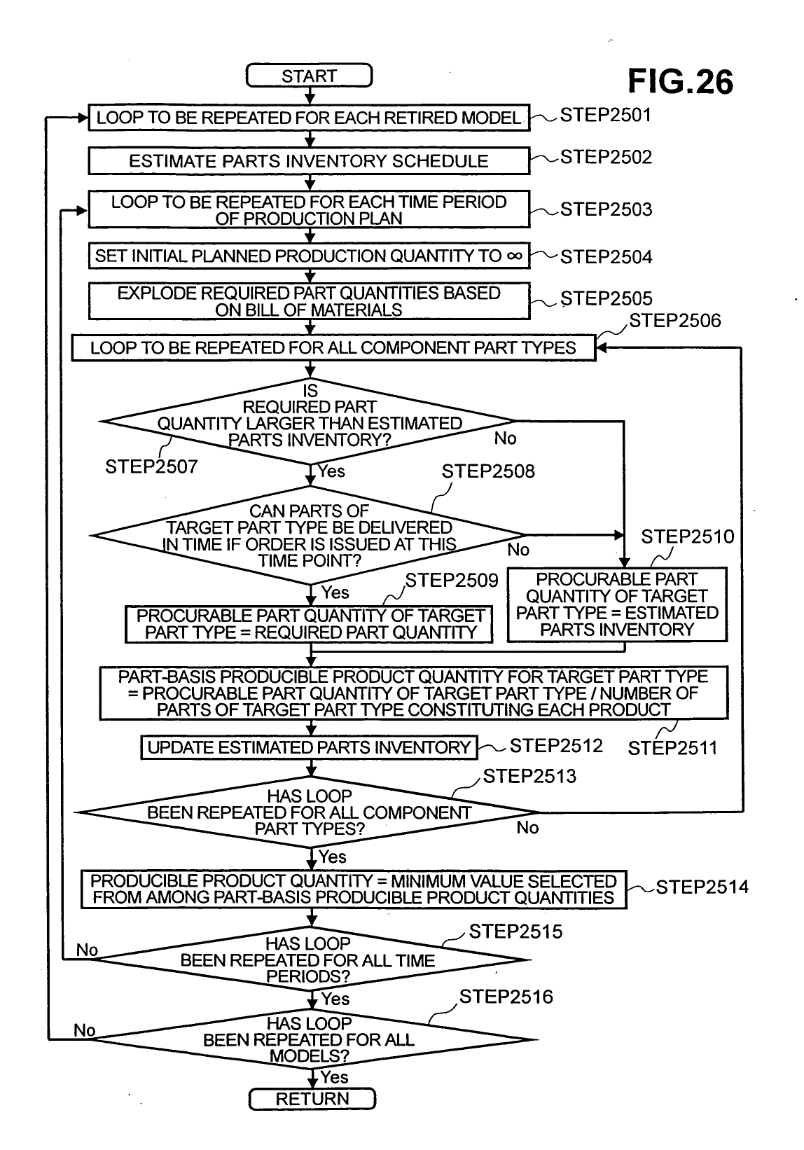

FIG. 26 shows the details of step 1603. This example shows a method for calculating the number of products which can be produced (producible product quantity) for each model. First of all, step 2501 starts a loop consisting of the subsequent steps 2502 through 2515 to be repeated for each retired model.

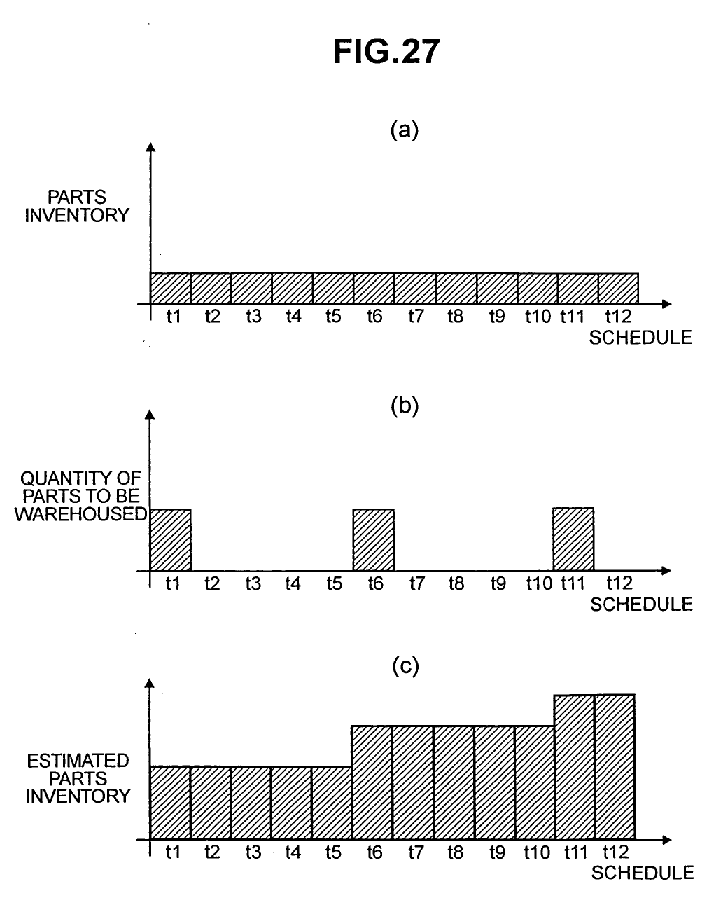

Step 2502 estimates the inventory schedule of each part type based on the above current parts inventory and the parts delivery schedule. The inventory schedule is obtained by adding the quantity of parts to be warehoused to the current part inventory over all time periods. FIG. 27 shows an example of this estimation. FIG. 27(a) shows the inventory quantity of the part c106. Specifically, the horizontal axis indicates each time period of the schedule, while the vertical axis indicates the inventory quantity, taking into no account the quantity of the parts to be warehoused or retrieved. In FIG. 27(b), the horizontal axis indicates each time period of the schedule, while the vertical axis indicates the quantity of the parts c1706 to be warehoused. Specifically, FIG. 27(b) indicates that parts will be warehoused in the time periods t1, t6, and t11. In FIG. 27(c), the horizontal axis indicates each time period of the schedule, while the vertical axis indicates the estimated inventory quantity of the parts c1706 including the quantity of the parts to be warehoused shown in FIG. 27(b).

Then, step 2503 starts a loop consisting of the subsequent steps 2504 through 2514 to be repeated for each time period of the production schedule. The length of each time period for which the loop is repeated can be freely set by the operator. Then, step 2504 sets the initial planned product quantity to ∞. After that, step 2505 explodes a target model (product) into required part quantities based on the above information on a bill of materials.

Then, step 2506 starts a loop consisting of the subsequent steps 2507 through 2512 to be repeated for each component part type. Step 2507 determines whether the above exploded required part quantity for each component part type is larger than the estimated part inventory quantity for that component part type. If it is determined at step 2507 that the required part quantity is larger than the estimated part inventory quantity, the processing flow proceeds to step 2508. If it is determined that the required part quantity is not larger than the estimated part inventory quantity, on the other hand, the processing flow proceeds to step 2510.

Step 2508 checks whether parts of a target part type can be delivered in time if the order is newly issued at this time point. If the parts can be delivered in time, the processing flow proceeds to step 2509.

If the parts cannot be delivered in time, on the other hand, the processing flow proceeds to step 2510. Step 2509 sets the quantity of parts of the target part type which can be procured to be equal to the required part quantity. Step 2510 sets the quantity of parts of the target part type which can be procured to be equal to the estimated part inventory quantity. Both steps 2509 and 2510 proceed to step 2511.

Step 2511 divides the procurable part quantity for the target part type by the number of parts of that part type constituting each product to obtain a part-basis producible product quantity for the target part type. Then, step 2512 updates the part inventory schedule for all time periods after this time period. Specifically, step 2512 subtracts the estimated part inventory for this time period from the estimated part inventory for each time period after this time period and sets the result as the updated estimated part inventory for a respective time period.

Step 2513 determines whether the loop consisting of steps 2507 through 2512 has been repeated for all component part types. If it is determined that the loop consisting of steps 2507 through 2512 has been repeated for all component part types, the processing flow proceeds to step 2514. If it is determined that the loop has not yet been repeated for all component part types, on the other hand, the processing flow returns to step 2506. Step 2514 selects the minimum value from among the part-basis producible product quantities as the producible product quantity.

Then, step 2515 determines whether the loop consisting of steps 2504 through 2514 has been repeated for all time periods of the production schedule. If it is determined that the loop consisting of steps 2504 through 2514 has been repeated for all time periods of the production schedule, the processing flow proceeds to step 2516. If it is determined that the loop has not yet been repeated for all time periods of the production schedule, on the other hand, the processing flow returns to step 2503.

Step 2516 determines whether the loop consisting of steps 2502 through 2515 has been repeated for all retired models. If it is determined that the loop consisting of steps 2502 through 2515 has been repeated for all retired models, the processing flow ends. If it is determined that the loop has not yet been repeated for all retired models, on the other hand, the processing flow returns to step 2501.

As described above, by carrying out calculations for each model and each time period, it is possible to calculate the producible product quantity for each model in the case where all overstocked parts are assigned to the model. It should be noted that in addition to the above method in which a producible product quantity is calculated for each model, it is possible to employ a “priority-model-basis producible product quantity calculating” method which performs the steps of: giving priority to each retired model; calculating the producible product quantity for the retired model having the highest priority; and calculating the producible product quantity for the retired model having the second highest priority by use of the remaining parts (and so on). Furthermore, the producible product quantity for each retired model can be determined by using as an evaluation criterion an additional parts order quantity or gain and loss (described later) and employing a gradient method or a linear programming method such that the item selected as the evaluation criterion has a best value.

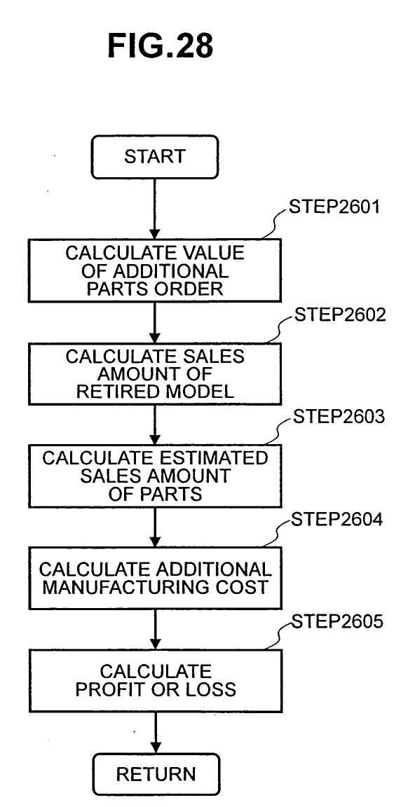

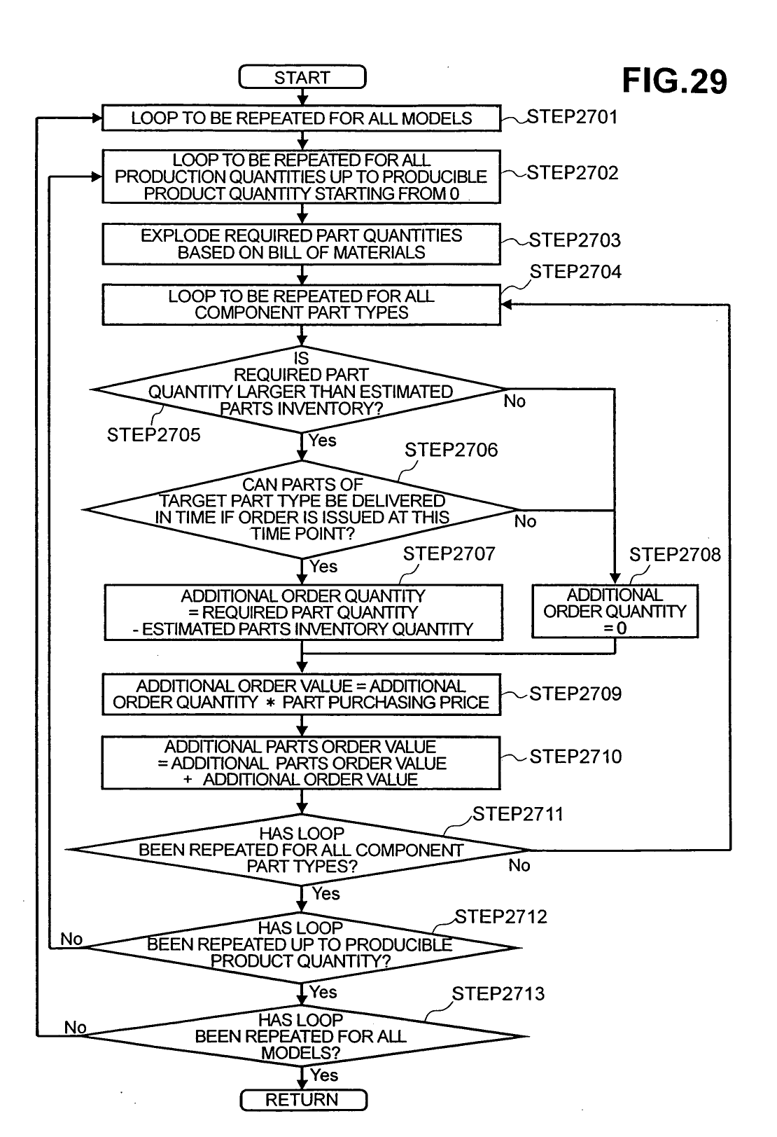

FIG. 28 shows the details of step 1604. First, step 2601 calculates the value of an additional parts order. This step is performed by the additional parts order estimating section 1518. FIG. 29 shows the details of the calculation method.

First of all, step 2701 starts a loop consisting of the subsequent steps 2702 through 2713 to be repeated for all models. Step 2702 starts a loop consisting of the subsequent steps 2703 through 2711 to be repeated for every production quantity starting from 0 up to the producible product quantity calculated at step 1603. Step 2703 explodes a target production quantity of products into required part quantities based on the information on a bill of materials. Step 2704 starts a loop consisting of the subsequent steps 2705 through 2710 to be repeated for all component part types.

Step 2705 determines whether the required part quantity for a target component part type is larger than the (corresponding) estimated parts inventory quantity. If it is determined that the required part quantity for the target component part type is larger than the estimated parts inventory quantity, the processing flow proceeds to step 2706. If it is determined that the required part quantity for the target component part type is not larger than the estimated parts inventory quantity, on the other hand, the processing flow proceeds to step 2708.

Step 2706 checks whether parts of the target part type can be delivered in time if the order is issued at this time point, that is, whether a new order for parts of the target part type can be placed. If the new order can be placed, the processing flow proceeds to step 2707. If the new order cannot be placed, on the other hand, the processing flow proceeds to step 2708. Step 2707 sets the additional order quantity to be equal to the required part quantity for the target part type minus the estimated part inventory quantity, and the processing flow proceeds to step 2709. Step 2708 sets the additional order quantity to 0, and the processing flow proceeds to step 2709.

Step 2709 calculates the value of the additional order for the target part type based on the additional (parts) order quantity. The value of the additional (parts) order is obtained by multiplying the additional order quantity by the purchasing price of the target part type. Then, step 2710 adds the value of the additional order for the target part type to the value of the additional parts order (total additional order) so that after the loop has been repeated for all component part types, the value of the additional parts order (total additional order) for each production quantity can be obtained.

Then, step 2711 determines whether the loop consisting of steps 2705 through 2710 has been repeated for all component part types. If it is determined that the loop has been repeated for all component part types, the processing flow proceeds to step 2712. If it is determined that the loop has not yet been repeated for all component part types, on the other hand, the processing flow returns to step 2704.

Step 2712 determines whether the loop consisting of steps 2703 through 2711 has been repeated for all possible production quantities. If it is determined that the loop has been repeated for all possible production quantities, the processing flow proceeds to step 2713. If it is determined that the loop has not yet been repeated for all possible production quantities, the processing flow returns to step 2702.

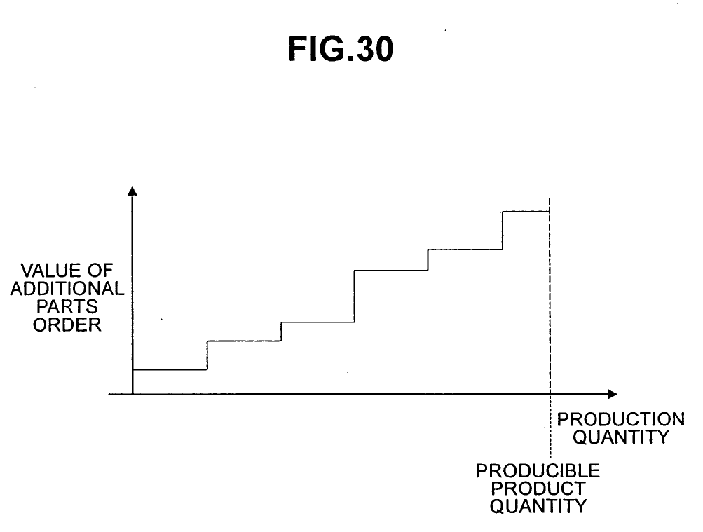

Step 2713 determines whether the loop consisting of steps 2702 through 2712 has been repeated for all models. If it is determined that the loop has been repeated for all models, the processing flow ends. If it is determined that the loop has not yet been repeated for all models, on the other hand, the processing flow returns to step 2701. A result from the above processing is shown in FIG. 30. In the figure, the horizontal axis indicates the production quantity, while the vertical axis indicates the value of the additional parts order.

Then, step 2602 calculates the estimated sales amount for each retired model.

This step is carried out by the above retired model sales amount calculating section 1519. Specifically, the retired model sale amount calculating section 1519 multiplies the above producible product quantity (for each retired model) by the above product selling price (information) for each time period shown in FIG. 21(b).

Then, step 2603 calculates the estimated parts sales amount. This step is carried out by the above retired parts selling schedule estimating section 1522. Specifically, the retired parts selling schedule estimating section 1522 performs the steps of: calculating the required part quantity for the producible product quantity (for each model) based on the producible product quantity and the above information on a bill of materials; subtracting the required part quantity for the producible product quantity from the above overstocked parts (quantity) to obtain the post-production overstocked parts (quantity); comparing the post-production overstocked parts (quantity) with the above sellable parts information shown in FIG. 22(c); if the surplus part quantity is larger than the sellable part quantity, setting the sellable part quantity of parts (of the target part type) as sellable; and if the surplus part quantity is not larger than the sellable part quantity, setting the post-production surplus part quantity of parts (of the target part type) as sellable. The above newly-set sellable part quantity is multiplied by the (corresponding) parts selling price included in the above parts selling price information to obtain the estimated parts sales amount. Furthermore, the retired parts selling schedule estimating section 1522 subtracts the sellable (part) quantity from the post-production surplus part (quantity) to obtain the post-sale overstocked parts (quantity). It should be noted that by setting a value of 0 for the sellable part quantity in FIG. 22(c), it is possible to evaluate a case in which parts are not sold.

Then, step 2604 calculates the additional manufacturing cost. This step is carried out by the additional manufacturing cost calculating section 1523. Specifically, the additional manufacturing cost calculating section 1523 multiplies the above producible product quantity by the above manufacturing cost (information) shown in FIG. 22(d). It should be noted, however, that if the production capability of the production line for the target products are fixed and furthermore the total production quantity does not increase even when the production quantity for each model is changed, the production line cost can be regarded as fixed. Accordingly, the manufacturing cost can be assumed to be zero, and the above manufacturing cost information may be set as such. An example in which the production capability of the production line is fixed is that production is scheduled to be carried out by 10,000 workers for 8 hours per day (that is, the production line has the corresponding production capability) and the wages for them are predetermined to be paid without fail.

Then, step 2605 calculates the profit and loss. This step is carried out by the retired parts disposal section 1520. This step calculates the profit and loss for each model based on the above retired model sales amount, estimated parts sales amount, additional parts order value, additional manufacturing cost, and post-sale overstocked parts (quantity) using the following formula (Formula 1). At that time, the production quantity and the part sales quantity are changed within the above producible product quantity and the above sellable part quantity, respectively.
profit or loss=retired model sales amount+estimated parts sales amount−additional parts order value−additional manufacturing cost−post-sale overstocked parts (quantity)×parts selling price (Formula 1)

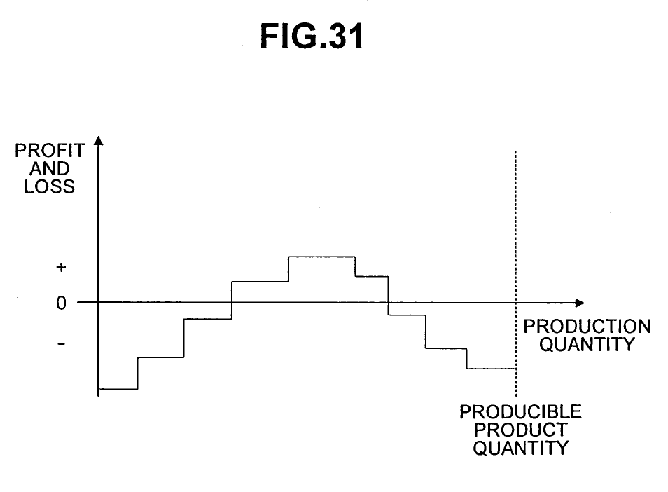

The above profit or loss is the output from step 1604. FIG. 31 shows this output. In the figure, the horizontal axis indicates the production quantity, while the vertical axis indicates the calculation result of the formula (Formula 1) for each production quantity, that is, the profit or loss.

Then, step 1605 determines a quantity to be added to the planned production quantity and a quantity to be added to the quantity of parts to be sold based on the above profit and loss for each model obtained at step 1604. This determination may be made by the operator interactively with the above operator input/output apparatus 1502. Or alternatively, the above retired parts disposal section 1520 may determine a production quantity and a part sales quantity at which the profit is maximized (loss is minimized) based on the above the profit and loss for each model. An example of the determination made interactively by the operator will be described later. The determined planned production quantity and part sales quantity are supplied to step 1606. Step 1606 determines whether any addition has been made to the planned production quantity at step 1605. If it is determined that some addition has been made to the planned production quantity, the processing flow returns to step 1602. If it is determined that no addition has been made to the planned production quantity, on the other hand, the processing flow ends. Step 1602 performs the steps of: when overstocked parts are estimated, exploding a quantity of products equal to the above quantity added to the planned production quantity at step 1605 based on the above information on a bill of materials; and subtracting the resultant additional production plan required-part quantity and the above part sales quantity from the surplus part quantity to obtain overstocked parts (quantity) left after the above additions to the production plan (planned production quantity) and the quantity of parts to be sold.

As described above, steps 1602 through 1606 are repeated, and then evaluation is made based on the profit and loss calculated at step 1604 to determine a retired model production plan and the quantity of parts to be sold (for each part type). With this arrangement, it is possible to dispose of the retired parts inventory and retired parts to be warehoused with minimum loss.

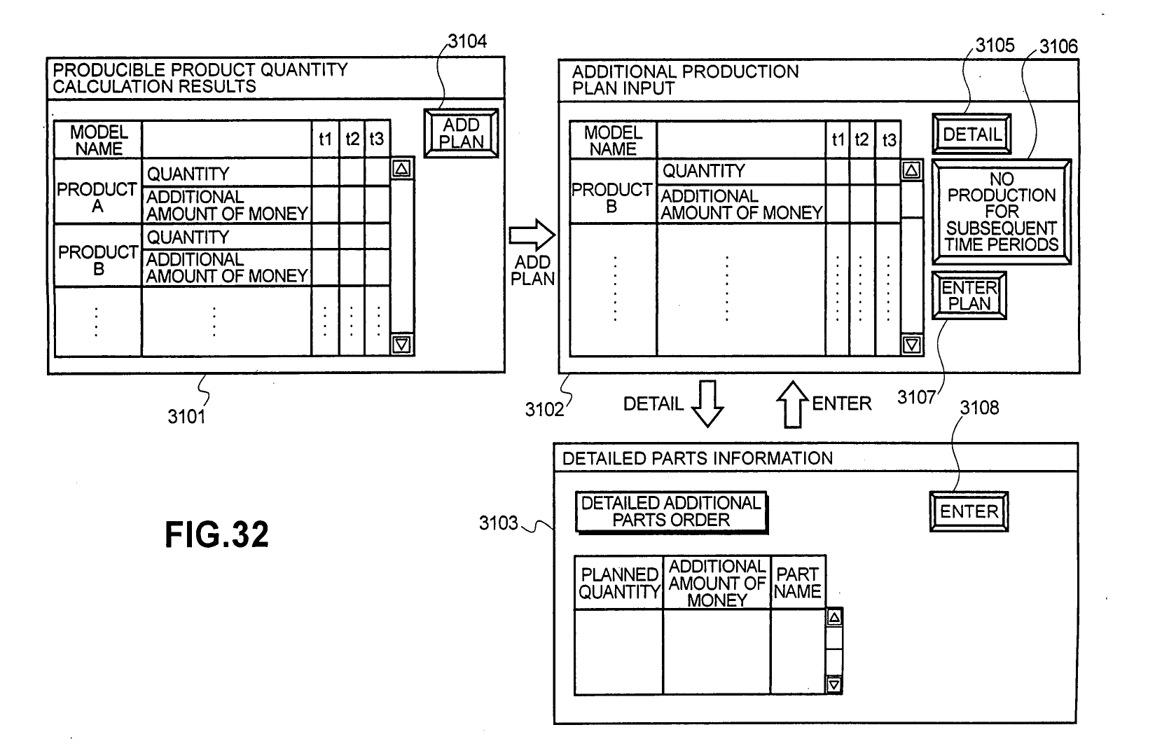

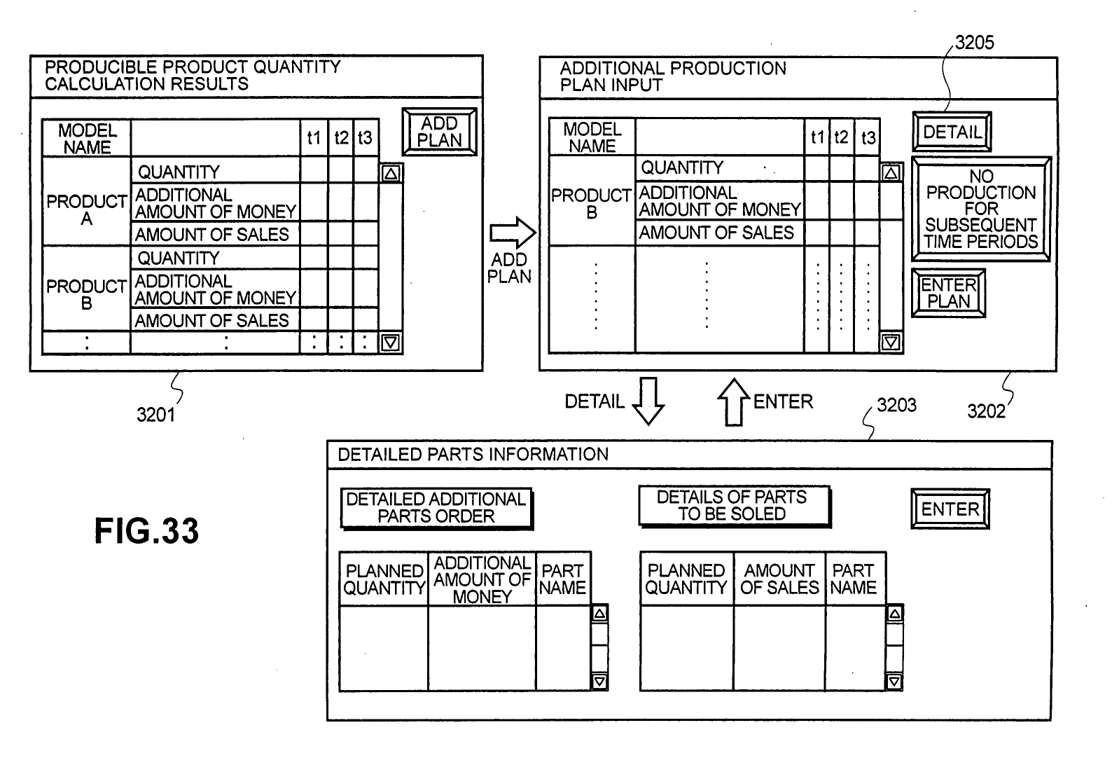

Description will be made below of an example in which the operator (planner) interactively drafts a production plan for a retired model with reference to FIGS. 32 and 33.

FIG. 32 shows interactive screens used when no parts are sold. First, a producible product quantity calculation results screen 3101 is displayed to the planner. This screen indicates the producible product quantity for each model in each time period and the value of the corresponding additional (parts) order. On the screen, the planner selects a model whose production plan is to be drafted by comparing the selling prices of models to one another. If the operator (planner) selects a field of a target model by use of a mouse or a keyboard and further selects an Add Plan button 3104 by use of a mouse or a keyboard, the producible product quantity for the target model in each time period and the value of the corresponding additional (parts) order are copied to an additional production plan input screen 3102.

On the additional production plan input screen 3102, the field to which the producible product quantity and the value of the corresponding additional parts order are copied is referred to as an additional production plan field. On the additional production plan input screen 3102, as an additional production plan, the planner enters a value, which is smaller than a respective producible product quantity, in the additional production plan field of each model for each time period by use of a mouse or a keyboard. When determining the value, if the planner selects the additional production plan field of a target model for a target time period by use of a mouse or a keyboard and further selects a Detail button 3105 by use of a mouse or a keyboard, a detailed parts information screen 3103 is displayed.

The detailed parts information screen 3103 displays, for each (possible) production quantity, the names of parts to be additionally ordered for the target model in the target time period and the value of the order. The planner checks each production quantity, the names of parts to be additionally ordered, the value of the order, and the selling price of the product, and selects a desired product production quantity by use of a mouse or a keyboard. After selecting the desired product production quantity, if the planner selects an Enter button 3108 by use of a mouse or a keyboard, the selected production quantity (for the production plan) is copied to the production quantity field of the target model for the target time period on the additional production plan input screen 3102. On the other hand, if the planner does not want to produce any products of the target model in the target and subsequent time periods, the planner selects the production quantity field of the target model for the target time period on the additional production plan input screen 3102 by use of a mouse or a keyboard and further selects a “No Production For Subsequent Time Periods” button 3106 by use of a mouse or a keyboard to set a value of 0 for the production quantity fields of the target model for the target time period and all the subsequent time periods on the additional production plan input screen 3102.

After drafting a final retired model production plan by repeating the above operation for each model, the planner selects an Enter Plan button 3107 on the additional production plan input screen 3102 by use of a mouse or a keyboard to decide an additional production plan for each retired model.

FIG. 33 shows interactive screens used when parts are sold. The producible product quantity calculation results screen 3201 corresponds to the producible product quantity calculation results screen 3101; the additional production plan input screen 3202 corresponds to the additional production plan input screen 3102; and the detailed parts information screen 3203 corresponds to the detailed parts information screen 3103. These screens shown in FIG. 33 are different from those shown in FIG. 32 in that they each indicate parts sales income to the planner. The planner first refers to the producible product quantity calculation results screen 3201, and checks the relationship between the producible product quantity and the value of the additional order for each model and the parts sales income earned when no production is carried out to select a model whose production plan is to be determined. The producible product quantity for the target model in each time period is copied to the additional production plan input screen 3202 by carrying out the same operation as that indicated by FIG. 32. As shown in FIG. 33, selecting a Detail button 3205 on the additional production plan input screen 3202 displays the detailed parts information screen 3203 which displays two tables to the planner: one including fields indicating production quantities, the names of parts to be additionally ordered, and the values of additional orders; and the other including fields indicating production quantities, the names of parts to be sold, and the sales amounts.

With this arrangement, the planner can aim to draft a production plan for a retired model in which the profit is maximized (or loss is minimized) based on the values of additional orders, the parts sales income, and the product selling price.

Description will be made below of a variation of the above example described with reference to FIGS. 17 to 33. In this example, no production plan (information) has been promised to the outside, and therefore it can be assumed that all models to be produced are retired models. In such a case, both the required parts explosion processing at step 1601 and the overstocked parts-extraction processing at step 1602 shown in FIG. 18 may be omitted. The retired parts estimating section 1516 may set both the parts inventory information stored in the parts inventory information storage section 1506 and the parts delivery schedule stored in the parts delivery schedule storage section 1507 as information on parts used for only retired models. Then, the producible product quantity calculating section 1517 may calculate the producible product quantity for each retired model.

Description will be made below of another variation of the above example described with reference to FIGS. 17 to 33. In this example, a production plan (information) has been already promised to the outside, and therefore it is necessary to execute the production plan even if it is of a retired model. In such a case, in the required parts explosion processing at step 1601 shown in FIG. 18, the MRP explosion apparatus 1515 may treat the production plan of a retired model whose production has been already promised, as that of a current model.

Description will be made below of still another variation of the above example described with reference to FIGS. 17 to 33. In this example, a production plan of a new model is stored as production planning information. In such a case, in the required parts explosion processing at step 1601 shown in FIG. 18, the MRP explosion apparatus 1515 may treat the production plan of a new model as that of a current model.

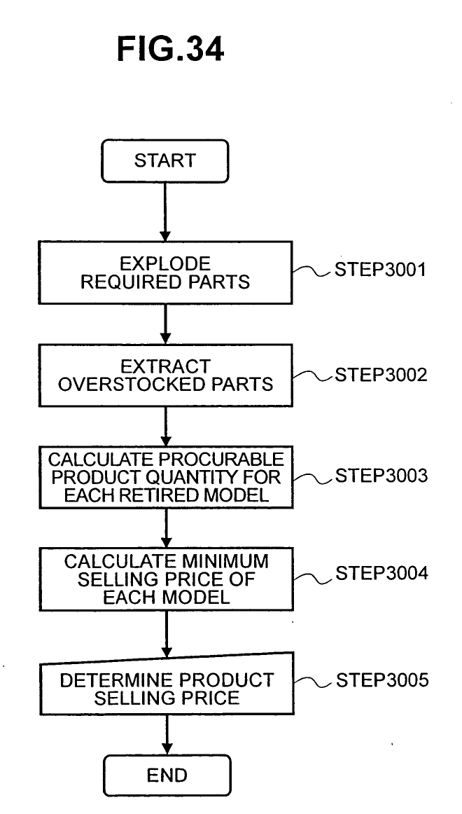

FIG. 34 shows an example of the product selling price determination algorithm according to the present invention. This algorithm determines the product selling price information stored in the product selling price information storage section 1510. Of the steps in FIG. 34, steps 3001 to 3003 perform the same processing as that performed at steps 1601 to 1603 shown in FIG. 18, respectively. Specifically, based on a predetermined production plan, step 3001 explodes (a product into) required part quantities and step 3002 extracts overstocked parts based on the exploded required part quantities. Step 3003 calculates the producible product quantity for each retired model in each time period based on the overstocked parts extracted at step 3002. Step 3004 calculates the minimum product selling pride for each model based on an estimated parts sales amount, an additional parts order value, an additional manufacturing cost, and (the quantity of) post-sale overstocked parts, using the following formula (Formula 2). At that time, the production quantity and the part sales quantity are changed within the above producible product quantity and sellable part quantity, respectively. This step (3004) is carried out by the product selling price calculating section 1521.
minimum product selling price=(−estimated parts sales amount+additional parts order value+additional manufacturing cost+post-sale overstocked parts quantity×parts selling price)/planned production quantity (Formula 2)

The above minimum product selling price is the output from step 3004.

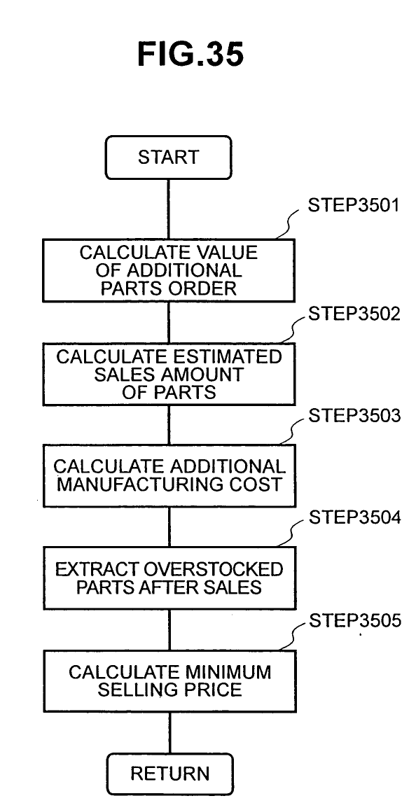

FIG. 35 shows the details of step 3004. In the figure, steps 3501, 3502, and 3503 perform the same processing as that performed at steps 2601, 2603, and 2604 shown in FIG. 28, respectively. Specifically, step 3501 calculates the value of an additional parts order; step 3502 calculates an estimated parts sales amount; and step 3503 calculates an additional manufacturing cost. Then, step 3504 extracts post-sale overstocked parts, and step 3505 calculates the minimum product selling price for each model by use of Formula 2.

Then, step 3005 determines a product selling price based on the minimum product selling price. This determination may be made by the operator interactively with the above operator input/output apparatus 1502. Or alternatively, the minimum product selling price may be set as the product selling price as it is. Since the determined product selling price of each model does not change with each time period, this constant value is exploded over all time periods of the schedule for each model. The product selling price thus exploded over all time periods of the schedule for each model is registered in the above product selling price information storage section 1510. This product selling price is used to perform the production plan adjustment processing shown in FIG. 18, making it possible to draft a production plan for a retired model with a small loss. It should be noted that after a product selling price has been registered in the product selling price information storage section 1510, the operator may set an estimated product selling price in the product selling price information storage section 1510 for each time period considering external conditions such as sales conditions. It should be further noted that if a satisfactory product selling price is not obtained for a model at step 3005, the determination of the product selling price of the model may be suspended. In such a case, the product selling price determination algorithm may be executed later, or the operator may set an estimated product selling price of the model in the product selling price information storage section 1510 for each time period through the operator input/output apparatus 1502.

Description will be made below of a variation of the above example described with reference to FIGS. 34 and 35. In this example, no production plan (information) has been promised to the outside, and therefore it can be assumed that all models to be produced are retired models. In such a case, both the required parts explosion processing at step 3001 and the overstocked parts extraction processing at step 3002 shown in FIG. 34 may be omitted. Instead, the retired parts estimating section 1516 may set both the parts inventory information stored in the parts inventory information storage section 1506 and the parts delivery schedule-stored in the parts delivery schedule storage section 1507 as information on parts used for only retired models. Then, the producible product quantity calculating section 1517 may calculate the producible product quantity for each retired model.

Description will be made below of another variation of the above example described with reference to FIGS. 34 and 35. In this example, a production plan (information) has been already promised to the outside, and therefore it is necessary to execute the production plan even if it is of a retired model. In such a case, in the required parts explosion processing at step 3001 shown in FIG. 34, the MRP explosion apparatus 1515 may treat the production plan of a retired model whose production has been already promised, as that of a current model.

Description will be made below of still another variation of the above example described with reference to FIGS. 34 and 35. In this example, a production plan of a new model is stored as production planning information. In such a case, in the required parts explosion processing at step 3001 shown in FIG. 34, the MRP explosion apparatus 1515 may treat the production plan of a new model as that of a current model.

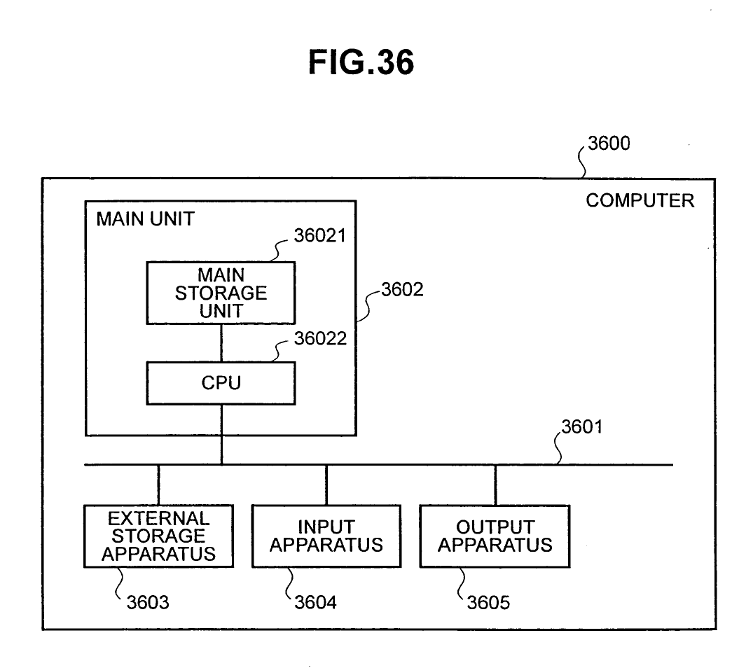

FIG. 36 shows the hardware configuration of the master production scheduling system 1500 shown in FIG. 17.

In the figure, a computer 3600 comprises: a bus 3601; a main unit 3602 connected to the bus 3601; an external storage apparatus 3603 connected to the bus 3601; an input apparatus 3604 connected to the bus 3601; and an output apparatus 3605 connected to the bus 3601. The main unit 3602 includes a main storage unit 36021 and a CPU (Central Processing Unit) 36022.

In the computer 3600, the main storage unit 36021 stores various programs and data necessary to execute these programs. The CPU 36022 executes a program stored in the main storage 36021 using data stored in the main storage 36021. The external storage apparatus 3603 may have a capacity larger than that of the main storage unit 36021. Programs and data to be stored in the main storage unit 36021 may be stored in the external storage apparatus 3603, and then read out from the external storage apparatus 3603 into the main storage unit 36021 by the CPU 36022 as necessary. As the external storage apparatus 3603, it is possible to use a floppy disk, which is a portable medium, a CD-ROM (Compact Disk Read-Only Memory), etc. in addition to a hard disk device.

In the computer 3600, the input apparatus 3604 is made up of an input control section (not shown) and an input section (not shown), such as a mouse or a keyboard, connected to the input control section. The input apparatus 3604 receives information entered by the operator by use of the input section such as a mouse or a keyboard. The output apparatus 3605 is made up of an output control section (not shown) and an output section (not shown), such as a display or a printer, connected to the output control section. The output apparatus 3605 can output to the output section, such as a display or a printer, data read from the external storage apparatus 3603 into the main storage unit 36021 by the CPU 36022. The output apparatus 3605 also can output a program execution result by the CPU 36022 to the output section such as a display or a printer.

Each apparatus in FIG. 17 described above is implemented by the components in FIG. 36 as follows.

The external storage apparatus 3603 realizes a function of the following sections in the data storage apparatus 1501 to permanently store temporarily-held information: the production planning information storage section 1504, the information on a bill of materials storage section 1505, the parts inventory information storage section 1506, the parts delivery schedule storage section 1507, the parts purchasing price information storage section 1508, the retired model information storage section 1509′, the product selling price information storage section 1510, the sellable product quantity information storage section 1511, the parts selling price information storage section 1512, the sellable parts information storage section 1513, and the manufacturing cost information storage section 1514. The main storage unit 36021, on the other hand, realizes another function of the above sections in which the operator refers to or updates stored information, or the operator registers new information.

The MRP explosion apparatus 1515 and the retired parts estimating section 1516, the producible product quantity calculating section 1517, the additional parts order estimating section 1518, the retired model sales amount calculating section 1519, the retired parts disposal section 1520, the product selling price calculating section 1521, the retired parts selling schedule estimating section 1522, and the additional manufacturing cost calculating section 1523 all included in the “retired model overstocked parts disposal method determining” apparatus 1503 are implemented by performing the steps of: storing into the external storage apparatus 3603 programs designed to carry out the operations of the above apparatuses and sections; reading these programs from the external storage apparatus 3603 into the main storage unit 36021; and executing the programs by use of the CPU 36022. When interactively drafting a production plan of a retired model, the operator can enter an instruction from the input apparatus 3604 while displaying the display screens as shown in FIGS. 32 and 33 in the output apparatus 3605 so that the production plan is drafted based on the entered instruction.

The operator input/output apparatus 1502 is implemented by the input apparatus 3604 and the output apparatus 3605.

It should be noted that the following hardware configuration, which is a variation of the above hardware configuration, may be employed. A plurality of computers are connected to one another such that they can exchange data. With this arrangement, the MRP explosion apparatus 1515 and the “retired model overstocked parts disposal method determining” apparatus 1503 may be each implemented by a separate computer.

According to the present invention, a master production scheduling system comprises a “retired model overstocked parts disposal method determining” apparatus, performing the steps of: extracting overstocked parts; calculating a producible product quantity for a retired model based on the overstocked parts; for each possible production quantity within the producible product quantity, calculating a sales amount, parts sales income to be earned from sales of parts left after the production, the value of an additional parts order, an additional manufacturing cost, and an inventory value for unsold parts; and selecting one of three options (measures) such as (1) produce products (utilizing the overstocked parts) and make efforts to increase the sales, (2) sell the overstocked parts as they are, and (3) abandon the overstocked parts as they are; wherein when one of the above measures is executed, it is possible to prevent loss from increasing by evaluating beforehand the profit and loss based on the sales amount, the parts sales income, the value of the additional parts order, the additional manufacturing cost, and the inventory value.

### Industrial Usability

A master production scheduling system according to the present invention comprises a “retired model overstocked parts disposal method determining” means and is capable of determining a method for disposing of overstocked parts with minimum loss, making it possible to improve corporate financial measures.

1-5. (canceled)

6. A production plan adjusting method for clearing out an overstocked parts inventory by first comparing a product production plan prepared beforehand against a parts inventory and a parts delivery schedule to determine said overstocked parts inventory and then carrying out a combination of one or more measures selected from among adjustment of said production plan, adjustment of a product selling price, sale of parts, addition of a parts order, and abandon of a parts inventory, said combination minimizing loss, said method comprising the steps of:
calculating gross requirements for said product production plan prepared beforehand and comparing said gross requirements against said parts inventory and said parts delivery schedule to determine a surplus part type and the quantity of inventoried parts of said surplus part type and the quantity of parts of said surplus part type to be warehoused;
based on said quantity of inventoried parts of said surplus part type and said quantity of parts of said surplus part type to be warehoused, calculating a producible product quantity for a retired model;
based on said overstocked parts inventory, said parts delivery schedule, said producible product quantity for said retired model, and a manufacturing cost, estimating, for each production quantity for said retired model, parts to be additionally ordered, a value of an additional order for said parts to be additionally ordered, an additional manufacturing cost, parts which are not used for said retired model, and the quantity of said parts which are not used for said retired model;
calculating a sales amount for each production quantity (for said retired model) based on a selling price of said retired model, and calculating parts sales income and an unsold parts depreciation on an assumption that an upper limit sellable quantity of said parts which are not used are sold; and
determining a production quantity for said retired model at which a difference obtained as a result of subtracting entire expenditure from entire income is maximized so as to clear out said overstocked parts inventory with minimum loss, said entire expenditure being a sum of said value of said additional order, said additional manufacturing cost, and said unsold parts appraisal loss, said entire income being a sum of said sales amount for said retired model and said parts sales income.

7-12. (canceled)

13. A production planning support system for helping adjust a production plan, which stores information on a producible product quantity for a retired model and information on a value of an additional order (which is an amount of money to be paid for parts to be additionally ordered) for each quantity of retired model products to be produced, said system displaying:
a producible product quantity calculation results screen for indicating to a planner a relationship between said producible product quantity for said retired model and said value of said additional order;
a detailed parts information screen for indicating to said planner a relationship between each production quantity for said retired model and said value of said additional order; and
an additional production plan input screen for enabling said planner to register a plan while referring to said producible product quantity calculation results screen and said detailed parts information screen;
wherein said production planning support system comprises:
a retired parts disposal section for helping said planner to, based on said value of said additional order and said producible product quantity for said retired model, determine a production plan for said retired model, said planner aiming to dispose of a retired parts inventory and parts listed in a retired parts delivery schedule with minimum loss;
whereby said retired parts inventory and parts listed in said retired parts delivery schedule can be disposed of with minimum loss.

14. A production planning support system for helping adjust a production plan, which stores information on a producible product quantity for a retired model, information on a value of an additional order (which is an amount of money to be paid for parts to be additionally ordered) for each quantity of retired model products to be produced, and information on estimated retired parts sales income to be earned from sales of retired parts which are not used for production of any product, said system displaying:
a producible product quantity calculation results screen for indicating to a planner relationships among said producible product quantity for said retired model, said value of said additional order, and said estimated retired parts sales income;
a detailed parts information screen for indicating to said planner relationships among each production quantity for said retired model, said value of said additional order, and said estimated retired parts sales income; and
an additional production plan input screen for enabling said planner to register a plan while referring to said producible product quantity calculation results screen and said detailed parts information screen;
wherein said production planning support system comprises:
a retired parts disposal section for helping said planner to, based on said value of said additional order, said estimated retired parts sales income, and said producible product quantity for said retired model, draft a plan, said planner aiming to dispose of a retired parts inventory and parts listed in a retired parts delivery schedule with minimum loss;
whereby said retired parts inventory and parts listed in said retired parts delivery schedule can be disposed of with minimum loss.

15. A production plan adjusting method capable of adjusting a production plan, comprising the steps of:
storing production planning information on a product, information on a bill of materials including names of parts constituting said product and time required for manufacturing said product from said parts, parts inventory information, a parts delivery schedule, parts purchasing price information, and retired model information;
based on said production planning information and said information on a bill of materials, exploding a product to be produced into gross requirements;
comparing said gross requirements against said parts inventory information and said parts delivery schedule to determine overstocked parts from among parts listed in a retired parts inventory and a retired parts delivery schedule;
based on said retired model information, said information on a bill of materials, said retired parts inventory, and said retired parts delivery schedule, calculating a producible product quantity for a retired model:
based on said producible product quantity for said retired model, said information on a bill of materials, said parts purchasing price information, said retired parts inventory, and said retired parts delivery schedule, calculating a value of an additional order (which is an amount of money to be paid for parts to be additionally ordered) for each quantity of retired model products to be produced;
based on said value of said additional order and said producible product quantity for said retired model, drafting a production plan for said retired model in which said value of said additional order is minimized; and
whereby said retired parts inventory and parts listed in said retired parts delivery schedule can be disposed of with minimum loss.

16. A production plan adjusting method capable of adjusting a production plan, comprising the steps of:
storing production planning information on a product, information on a bill of materials including names of parts constituting said product and time required for manufacturing said product from said parts, parts inventory information, a parts delivery schedule, parts purchasing price information, retired model information, retired model product selling price information, retired model sellable product quantity information, parts selling price information, sellable parts information, and manufacturing cost information;
based on said production planning information and said information on a bill of materials, exploding a product to be produced into gross requirements;
comparing said gross requirements against said parts inventory information and said parts delivery schedule to determine overstocked parts from among parts listed in a retired parts inventory and a retired parts delivery schedule;
based on said retired model information, said information on a bill of materials, said retired parts inventory, and said retired parts delivery schedule, calculating a producible product quantity for a retired model;
based on said producible product quantity for said retired model, said information on a bill of materials, said parts purchasing price information, said retired parts inventory, and said retired parts delivery schedule, calculating a value of an additional order (which is an amount of money to be paid for parts to be additionally ordered) for each quantity of retired model products to be produced;
based on said producible product quantity for said retired model, said information on a bill of materials, said retired parts inventory, said retired parts delivery schedule, said parts selling price information, and said sellable parts information, calculating estimated retired parts sales income to be earned from sales of retired parts which are not used for production of any product;
based on said producible product quantity for said retired model, said information on a bill of materials; and said manufacturing cost information, calculating an additional manufacturing cost for each quantity of retired model products to be produced; and
based on said value of said additional order, said producible product quantity for said retired model, said retired model product selling price information, said retired model sellable product quantity information, said estimated retired parts sales income, and said additional manufacturing cost, drafting a production plan for said retired model in which profit is maximized (or loss is minimized);
whereby said retired parts inventory and parts listed in said retired parts delivery schedule can be disposed of with minimum loss.

17. A computer-readable storage medium which stores a program for causing a computer to perform a production plan adjusting method capable of adjusting a production plan, said program having the functions of:
storing production planning information on a product, information on a bill of materials including names of parts constituting said product and time required for manufacturing said product from said parts, parts inventory information, a parts delivery schedule, parts purchasing price information, and retired model information;
based on said production planning information and said information on a bill of materials, exploding a product to be produced into gross requirements;
comparing said gross requirements against said parts inventory information and said parts delivery schedule to determine overstocked parts from among parts listed in a retired parts inventory and a retired parts delivery schedule;
based on said retired model information, said information on a bill of materials, said retired parts inventory, and said retired parts delivery schedule, calculating a producible product quantity for a retired model;
based on said producible product quantity for said retired model, said information on a bill of materials, said parts purchasing price information, said retired parts inventory, and said retired parts delivery schedule, calculating a value of an additional order (which is an amount of money to be paid for parts to be additionally ordered) for each quantity of retired model products to be produced;
based on said value of said additional order and said producible product quantity for said retired model, drafting a production plan for said retired model in which said value of said additional order is minimized; and
whereby said retired parts inventory and parts listed in said retired parts delivery schedule can be disposed of with minimum loss.

18. A computer-readable storage medium which stores a program for causing a computer to perform a production plan adjusting method capable of adjusting a production plan, said program having the functions of:
storing production planning information on a product, information on a bill of materials including names of parts constituting said product and time required for manufacturing said product from said parts, parts inventory information, a parts delivery schedule, parts purchasing price information, retired model information, retired model product selling price information, retired model sellable product quantity information, parts selling price information, sellable parts information, and manufacturing cost information;
based on said production planning information and said information on a bill of materials, exploding a product to be produced into gross requirements;
comparing said gross requirements against said parts inventory information and said parts delivery schedule to determine overstocked parts from among parts listed in a retired parts inventory and a retired parts delivery schedule;
based on said retired model information, said information on a bill of materials, said retired parts inventory, and said retired parts delivery schedule, calculating a producible product quantity for a retired model;
based on said producible product quantity for said retired model, said information on a bill of materials, said parts purchasing price information, said retired parts inventory, and said retired parts delivery schedule, calculating a value of an additional order (which is, an amount of money to be paid for parts to be additionally ordered) for each quantity of retired model products to be produced;
based on said producible product quantity for said retired model, said information on a bill of materials, said retired parts inventory, said retired parts delivery schedule; said parts selling price information; and said sellable parts information, calculating estimated retired parts sales income to be earned from sales of retired parts which are not used for production of any product; based on said producible product quantity for said retired model, said information on a bill of materials, and said manufacturing cost information, calculating an additional manufacturing cost for each quantity of retired model products to be produced;
based on said value of said additional order, said producible product quantity for said retired model, said retired model product selling price information, said retired model sellable product quantity information, said estimated retired parts sales income, and said additional manufacturing cost, drafting a production plan for said retired model in which profit is maximized (or loss is minimized); and
whereby said retired parts inventory and parts listed in said retired parts delivery schedule can be disposed of with minimum loss.
